(19) United States
(12) Patent Application Publication
(10) Pub. No.: US 2026/0319488 A1
(43) Pub. Date: Oct. 15, 2026

(54) Systems and Methods for Autonomous AI Agent Control in Robot Operations

(71) Applicant: Salesforce, Inc., San Francisco, CA (US)

(72) Inventors: Charles Hart ISAACS, San Francisco, CA (US); Taksina EAMMANO, Orinda, CA (US); Marc BENIOFF, San Francisco, CA (US)

(21) Appl. No.: 19/253,456

(22) Filed: Jun. 27, 2025

Related U.S. Application Data
(60) Provisional application No. 63/789,331, filed on Apr. 15, 2025.

(51) Int. Cl. G05D 1/221; G05D 1/69; G05D 101/00; G05D 101/15; G05D 109/10

(52) U.S. Cl. CPC G05D 1/221; G05D 1/69; G05D 2101/15; G05D 2101/22; G05D 2109/10

(57) ABSTRACT

A computing services environment may include a database system configured to store a plurality of representations of training records associated with a remote robot management system, and an agent platform including metadata entries corresponding to a plurality of agent instances, the metadata entries defining actions capable of being autonomously performed within the computing services environment by the agent instances, the actions being determined based on the representations of training records associated with the remote robot management system. The computing services environment may include a generative language model interface providing access to generative language models, and an orchestration and planning service configured to instantiate and execute agent instances associated with the remote robot management system, wherein executing one or more agent instances comprises determining one or more actions of the plurality of actions to generate command information for the remote robot management system to perform the one or more actions.

### CROSS-REFERENCE TO RELATED APPLICATIONS

This application claims the benefit under 35 U.S.C. § 119(e) of US Provisional Patent Application 63/789,331 (Attorney Docket No. SFDCP 257P) by Charles Isaacs et. al, titled: “SYSTEMS AND METHODS FOR AUTONOMOUS AI AGENT CONTROL IN ROBOT OPERATIONS”, filed on Apr. 15, 2025, which is incorporated herein by reference in its entirety for all purposes.

### FIELD OF TECHNOLOGY

This patent application relates generally to database systems, and more specifically to autonomous artificial intelligence agents implemented in the context of database systems.

### BACKGROUND

Remote robots may be implemented in a variety of operational contexts, such as warehouses and other manufacturing facilities. Such robots may be autonomous or partially autonomous and may be trained to performed various tasks within such operational contexts. During training of such tasks, the robot may be remotely controlled by a human user via one or more input devices, such as a tablet and a joystick. The user may pilot the robot around the facility and perform the tasks which are then stored as training information. Conventional techniques for training and managing such robots remain limited in their ability to efficiently train and operate such robots.

### BRIEF DESCRIPTION OF THE DRAWINGS

The included drawings are for illustrative purposes and serve only to provide examples of possible structures and operations for the disclosed inventive systems, apparatus, methods, and computer program products for artificial intelligence agent creation based on database records in a database system. These drawings in no way limit any changes in form and detail that may be made by one skilled in the art without departing from the spirit and scope of the disclosed implementations.

FIG. 1 illustrates an autonomous artificial intelligence agent method, performed in accordance with one or more embodiments.

FIG. 2 illustrates various elements that may be included within a computing services environment, configured in accordance with one or more embodiments.

FIG. 3 illustrates an autonomous robot control method, performed in accordance with one or more embodiments.

FIG. 4 illustrates an additional autonomous robot control method, performed in accordance with one or more embodiments.

FIG. 5 illustrates another autonomous robot control method, performed in accordance with one or more embodiments.

FIG. 6 illustrates an additional autonomous robot control method, performed in accordance with one or more embodiments.

FIG. 7 illustrates another autonomous robot control method, performed in accordance with one or more embodiments.

FIG. 8 illustrates a user interface for artificial intelligence agent creation, configured in accordance with one or more embodiments. As shown in image 800,

FIG. 9 illustrates a user interface for autonomous robot management, configured in accordance with one or more embodiments.

FIG. 10 illustrates a user interface for autonomous robot management, configured in accordance with one or more embodiments.

FIG. 11 illustrates a user interface for autonomous robot management, configured in accordance with one or more embodiments.

FIG. 12 illustrates a user interface for autonomous robot management, configured in accordance with one or more embodiments.

FIG. 13 illustrates a user interface for autonomous robot management, configured in accordance with one or more embodiments.

FIG. 14 illustrates a user interface for autonomous robot management, configured in accordance with one or more embodiments.

FIG. 15 illustrates a user interface for autonomous robot management, configured in accordance with one or more embodiments.

FIG. 16 illustrates a user interface for autonomous robot management, configured in accordance with one or more embodiments.

FIG. 17 illustrates a user interface for autonomous robot management, configured in accordance with one or more embodiments.

FIG. 18 illustrates a user interface for autonomous robot management, configured in accordance with one or more embodiments.

FIG. 19 illustrates a computing services environment, configured in accordance with one or more embodiments.

FIG. 20 illustrates a method providing an overview of the lifecycle of an autonomous agent, performed in accordance with one or more embodiments.

FIG. 21 illustrates a trust model for the autonomous agent platform, configured in accordance with one or more embodiments.

FIG. 22 illustrates an architecture diagram of elements of the computing services environment, configured in accordance with one or more embodiments.

FIG. 23 shows a block diagram of an example of an environment that includes an on-demand database service configured in accordance with some implementations.

FIG. 24A shows a system diagram of an example of architectural components of an on-demand database service environment, configured in accordance with some implementations.

FIG. 24B shows a system diagram further illustrating an example of architectural components of an on-demand database service environment, in accordance with some implementations.

FIG. 25 illustrates one example of a computing device, configured in accordance with one or more embodiments.

### DETAILED DESCRIPTION

### Introduction

According to various embodiments, an autonomous agent may be defined based on a set of resources such as one or more prompt templates, action definitions, reasoning frameworks, and the like. The autonomous agent may be instantiated at runtime by an agent service at a computing services environment. Executing the autonomous agent may involve operations such as transmitting a planning prompt to a generative language model. The planning prompt may include both input data and natural language instructions to be executed by the generative language model. The input data may include, for instance, one or more chat utterances, data retrieved from a database system or other such sources, and/or other types of initialization information. The generative language model may then execute natural language instructions in the planning prompt to determine novel text based on the input data. The novel text may include action identifiers corresponding to action definitions. The computing services environment may then execute the natural language instructions to include novel text. The novel text may include identifiers corresponding to actions that may be taken within the computing services environment. Alternatively, or additionally, the novel text may include response text to be provided to a user, for instance via a chat interface. The computing services environment may then execute the actions corresponding to the action identifiers.

In some embodiments, techniques and mechanisms described herein may provide the ability to generate autonomous artificial intelligence agents based on training data originating from remote robots in an operational environment, such as a warehouse or other facility. The remote robots may be trained locally at the facility, and such training data may be stored that define tasks for which the robots are trained. The training data may be uploaded to a computing services environment, and the tasks may be parsed and mapped to actions for autonomous agents. The autonomous agents may then be deployed and accessible via services and architecture of the computing services environment. Accordingly, the remote robot may be on-boarded as an entity with an associated autonomous agent, and the autonomous agent may be used to control and issue commands to the remote robot. Thus, the autonomous agent platform may be integrated with the robot OS, and used to control the remote robot in a manner consistent with its previously trained tasks that were trained and stored locally.

### Autonomous Agent Creation and Management of Robots

Remote robots may be implemented in various different operational environments. More specifically, remote robots may be implemented using a remote robot management system in which the remote robot is configured to implement programmed operations in an autonomous manner that may be managed by the remote management system. For example, a remote robot may be a manufacturing robot or some other industrial robot that is configured to perform operations in a manufacturing environment, such as safety inspections or manufacturing operations. Conventional techniques for training and managing operations of such remote robots remain limited because they often require manual training of the remote robots as well as manual management of the remote robots. Such manual management may require a human user to be present at the location of the remote robot to ensure that the remote robot is able to perform its designated tasks.

Embodiments disclosed herein provide autonomous artificial intelligence agents for control of remote robots in various different operational contexts. As will be discussed in greater detail below, existing programmed tasks and operations may have been programmed locally at the operational environment of the remote robot. Such programmed operations may be integrated with a computing services environment of an autonomous agent platform. Moreover, such programmed operations may be used to configure, instantiate, and execute one or more autonomous agent instances in the computing services environment. Such autonomous agent instances may be configured to generate command information for the remote robot and deploy such command information to the remote robot via, for example, a communications network of the remote robot management system. In this way, remote robots may be onboarded and recognized as entities within the context of the computing services environment of the autonomous agent platform, and the remote robots may be configured and controlled via one or more autonomous agent instances.

In one example, a remote robot may be configured to perform one or more inspection operations at a warehouse. For example, the remote robot may be trained to perform operations such as inspecting a pressure gauge on industrial equipment. The operations may include navigating along a designated path withing a warehouse, capturing an image of the gauge, uploading the image, and returning to a base station within the warehouse. In some embodiments, training of such operations may have been performed by a user located at the warehouse and stored locally in a data record as training information.

In various embodiments, remote robots may be implemented in other operational contexts as well. For example, remote robots may be implemented in associated with remote robot management systems at other types of facilities, as well as hospitality and service operations, such as hotels and offices. Accordingly, while various embodiments disclosed herein describe operations in warehouses and manufacturing facilities, it will be appreciated that embodiments disclosed herein contemplate operations in any suitable environment. For example, training information may include trained operations to perform cleaning and/or maintenance operations in a hotel or resort. Moreover, training information may include trained operations for cleaning, administrative, and/or maintenance operations in an office building.

As will be discussed in greater detail below, the training information may be uploaded to a computing services environment, and trained operations may be extracted from the training information. Moreover, various autonomous agent instances may be configured and deployed based on the trained operations. For example, various autonomous agent actions may be determined, and a corresponding autonomous agent instance may be instantiated and deployed within the computing services environment for the remote robot. Moreover, the remote robot may be registered as an asset within the computing services environment thus making the remote robot recognized and discoverable within the computing services environment by other on-demand services and applications. Interactions between the remote robot and such other on-demand services and applications may be managed by the autonomous agent instance. Moreover, the autonomous agent instance may be used to generate command information for the remote robot thus providing autonomous control of the remote robot via integration with the autonomous agent platform.

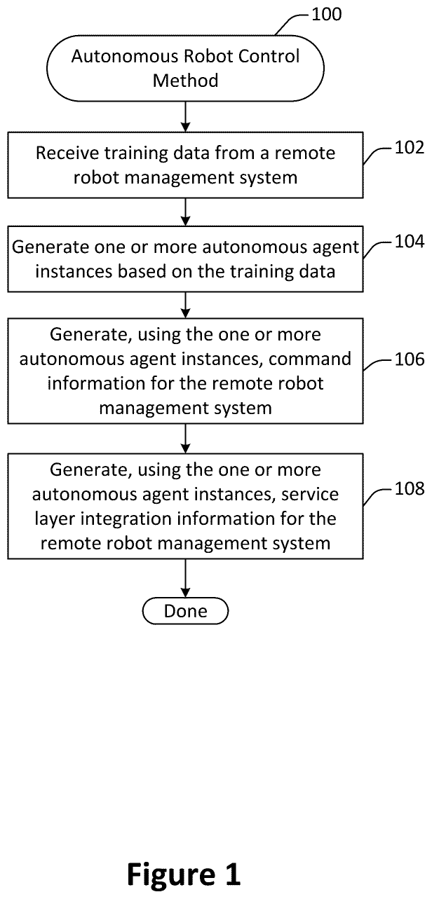

FIG. 1 illustrates an autonomous artificial intelligence agent method, performed in accordance with one or more embodiments. As will be discussed in greater detail below, a method, such as method 100, may be performed to integrate one or more remote robots with autonomous artificial agents implemented in an autonomous agent platform. More specifically, such remote robots may have training information that is used to generate and configure instances of such autonomous agents, and such autonomous agents and other features provided by the autonomous agent platform may then be used to control operations of the remote robots.

Method 100 may perform operation 102 during which training data may be received from a remote robot management system. In various embodiments, the remote robot management system may be a remote facility, such as a warehouse or manufacturing facility having automated robots. While some examples of facilities are provided, it will be appreciated that any suitable facilities may be contemplated and disclosed herein. In various embodiments, the remote robots may be trained by an entity, such as a user, locally at that the remote facility. For example, a user may train the robot to perform a task, such as check on safety equipment such as a defibrillator, or perform safety inspections, such as checking valve pressures. Such training may be performed by the user using a tablet and joystick to control operation of the robot for such a task, and store the trained task locally as training data generated by the user during such programming. Such training data may be stored in a native format of the remote robot, such as a robot walk file, or other file compatible with a robot operating system (OS). In one example, the training data is stored in a JSON or XML format. In various embodiments, the training data may be transmitted from the remote facility to one or more components of a computing services environment and stored in a database system of the computing services environment.

Method 100 may perform operation 104 during which one or more autonomous agent instances may be generated based on the training data. As will be discussed in greater detail below, the training data may be received in a format native to the remote robot. The training data may be parsed to extract trained operations from the training data. The trained operations may be mapped to actions associated with an autonomous agent instance. Accordingly, an autonomous agent instance may be generated and configured for each remote robot for which training data has been received, and trained operations may be mapped to actions performable by the autonomous agent instances.

Method 100 may perform operation 106 during which command information may be generated for the remote robot management system. In various embodiments, such command information may be generated using the one or more autonomous agent instances. Such command information may include commands to perform one or more trained operations. Moreover, such command information may be generated in a format native to the robot and compatible with the robot OS. In one example, the autonomous agent instance generates an output that includes Python code.

Method 100 may perform operation 102 during which service layer integration information may be generated for the remote robot management system. In various embodiments, such service layer integration information is generated using the one or more autonomous agent instances. Such service layer integration information may include routing and endpoint information enabling communication between the remote robot and one or more other components of the computing services environment. For example such service layer integration information may include Mulesoft code that identifies one or more Mulesoft endpoints. Such Mulesoft endpoints may be used by the remote robot to upload information, such as images, to one or more components of the computing services environment, such as a database system.

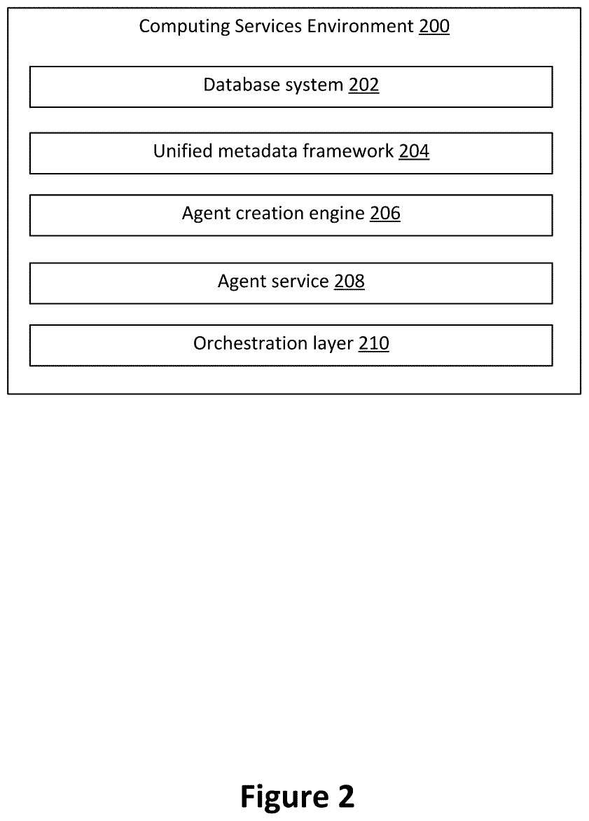

FIG. 2 illustrates various elements that may be included within a computing services environment, configured in accordance with one or more embodiments. In various embodiments, a computing services environment, such as computing services environment 200, may be configured to implement an autonomous agent platform used to generate and deploy autonomous agent instances as disclosed herein. Accordingly, computing services environment 200 may be configured to generate and deploy autonomous agent instances for remote robots, as will be discussed in greater detail below.

In various embodiments, computing services environment 200 includes database system 202 that is configured to store a plurality of representations of training records associated with a remote robot management system. As similarly discussed above, such training records may be received from a remote facility and may include training data representing trained operations for a remote robot.

In some embodiments, computing services environment 200 may include components of an autonomous agent platform, such as unified metadata framework 204, agent creation engine 206, and agent service 208. Such components may be configured to include metadata entries corresponding to a plurality of agent instances, where such metadata entries define a plurality of actions capable of being autonomously performed within the computing services environment by the plurality of agent instances. As will be discussed in greater detail below, the plurality of actions may be determined based on the representations of training records associated with the remote robot management system.

In various embodiments, computing services environment 200 further includes orchestration layer 210 that is configured to instantiate and execute one or more autonomous agent instances associated with the remote robot management system. As will be discussed in greater detail below, the executing of the one or more agent instances comprises determining one or more actions of the plurality of actions to generate command information for the remote robot management system to perform the one or more actions.

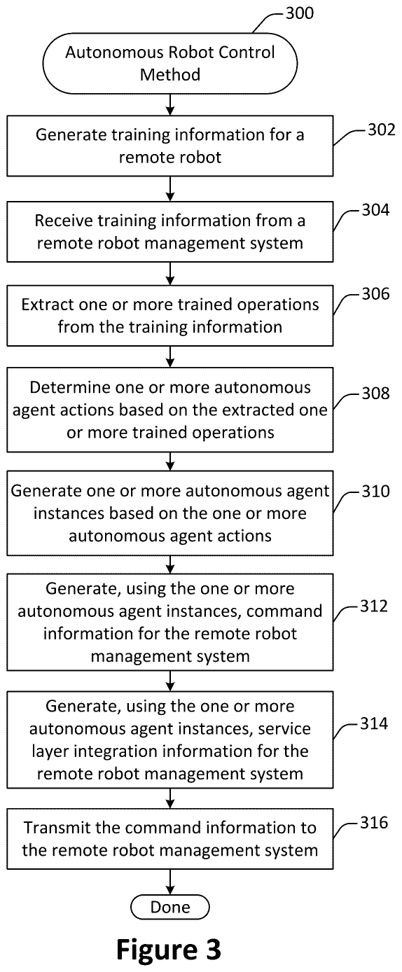

FIG. 3 illustrates an autonomous robot control method, performed in accordance with one or more embodiments. As will be discussed in greater detail below, a method, such as method 300, may be performed to integrate one or more remote robots with autonomous artificial agents implemented in an autonomous agent platform. More specifically, such remote robots may have training information that is used to generate and configure instances of such autonomous agents, and such autonomous agents and other features provided by the autonomous agent platform may then be used to control operations of the remote robots.

Method 300 may perform operation 302 during which training information may be generated. As similarly discussed above, training information may be generated at the facility for the remote robots based on training sessions where the robots are trained and programmed to perform various designated operations. For example, one or more training devices, such as a tablet and other input device, such as a joystick, may be used to guide a robot through one or more operations included in a designated task, also referred to as a robot “mission”. As also discussed above, such robot “missions” may include tasks such as safety inspection of gauges and/or other safety equipment, as well as other tasks, such as opening and closing doors. It will be appreciated that any suitable task may be included in the robot “mission”. As a result of the training, the training information may include one or more “walk” files which are data records configured to store, among other things, commands corresponding to the trained tasks. Such training information may be stored in a format such as XML or JSON. Such training information may be stored locally on the training device or at a data storage of a remote robot management system.

Method 300 may perform operation 304 during which training information may be received from a remote robot management system. As similarly discussed above, a remote robot management system may be a remote facility, such as a warehouse or manufacturing facility having automated robots. Accordingly, the remote facility may have a local network infrastructure for communicating with and commanding remote robots within the facility. The local network infrastructure may also be coupled to an external network and the Internet via a gateway or any other suitable network component. Accordingly, the remote robot management system may be configured to handle data exchange between remote robots and entities external to the facility.

As similarly discussed above, training information may be generated at the facility for the remote robots based on training sessions where the robots are trained and programmed to perform various designated operations. Such training information may be stored in a native format of the remote robot, such as a robot walk file or other file compatible with a robot operating system (OS), or in a JSON or XML format. In various embodiments, the training data may be transmitted by the remote robot management system from the remote facility to one or more components of a computing services environment and stored in a database system of the computing services environment. Such a transmission of the training information may be triggered manually by an entity or automatically after the training session has been completed for the remote robot. In various embodiments, the received training information is included in a custom data record and is also assigned a unique identifier. Such creation of the custom data record may be performed by a service that may be implemented as part of a service.

Method 300 may perform operation 306 during which one or more trained operations may be extracted from the training information. Accordingly, one or more components of the computing services environment may parse the received training information and extract identified trained operations from the received training information. Such trained operations may be identified based on headers, identifiers, or any other suitable identifying characteristic in the received code.

In various embodiments, an intermediate application executed in the computing services environment may be configured to process the training information included in the custom data record, and automatically generate XML in a format of the autonomous agent platform. Accordingly, the intermediate application is configured to translate the received training information, which may be in a JSON, XML, or other format of the remote robot, into an XML format of the autonomous agent platform based, at least in part, on one or more translation rules that may be defined by an entity, such as an administrator or manufacturer. The generated autonomous agent platform XML may then be uploaded to one or more other components of the computing services environment, such as a database system. In this way, the generated autonomous agent platform XML may include identifiable and referenceable sections corresponding to topics, actions, and instructions recognized by the autonomous agent platform, where such topics, actions, and instructions were generated based on the training information for the robot “missions” originally generated during operation 302.

Method 300 may perform operation 308 during which one or more autonomous agent actions may be determined based on the extracted one or more trained operations. Thus, according to some embodiments, the trained operations parsed from the received training information may be mapped to actions assigned to an autonomous agent instance that is generated for a remote robot. In this way, tasks that a remote robot was trained to perform may be mapped to actions defining, at least in part, an autonomous agent instance. As will be discussed in greater detail below, such a mapping enables integration of such training information with the infrastructure of the autonomous agent platform, and enables the autonomous agent instance to generate command information for such trained operations. As will also be discussed in greater detail below, the mapping of such trained operations to autonomous agent instance actions may be performed based on a designated mapping stored in a database system, or may be performed based on a received input. In one example, a user may provide an input to a user interface that maps trained operations to action for the autonomous agent instance.

Method 300 may perform operation 310 during which one or more autonomous agent instances may be generated based on the one or more autonomous agent actions. Accordingly, once the actions have been defined for the autonomous agent instance, the autonomous agent instance may be generated and deployed for its associated remote robot. Once deployed, the autonomous agent instance may interact with other components and services supported by the autonomous agent platform and computing services environment, thus enabling the remote robot to present as an entity within the autonomous agent platform and computing services environment via its associated autonomous agent instance.

Method 300 may perform operation 312 during which command information may be generated for the remote robot management system. As similarly discussed above, such command information may be generated using the one or more autonomous agent instances. Such command information may include commands to perform one or more trained operations. Moreover, such command information may be generated in a format native to the robot and compatible with the robot OS. In one example, the autonomous agent instance generates an output that includes Python code.

Method 300 may perform operation 314 during which service layer integration information may be generated for the remote robot management system. As similarly discussed above, such service layer integration information is generated using the one or more autonomous agent instances. Such service layer integration information may include routing and endpoint information enabling communication between the remote robot and one or more other components of the computing services environment. For example such service layer integration information may include Mulesoft code that identifies one or more Mulesoft endpoints. Such Mulesoft endpoints may be used by the remote robot to upload information, such as images, to one or more components of the computing services environment, such as a database system.

Method 300 may perform operation 316 during which the command information may be transmitted to the remote robot management system. In some embodiments, the autonomous agent instance may determine that code should be generated and sent to the remote robot, as may occur if it is determined that command information should be provided to command the remote robot to perform a designated operation. The code may be in a format native to the remote robot, and may be transmitted to the remote robot management system. The code may then be uploaded to the remote robot automatically, or with the assistance of a user located at the remote facility.

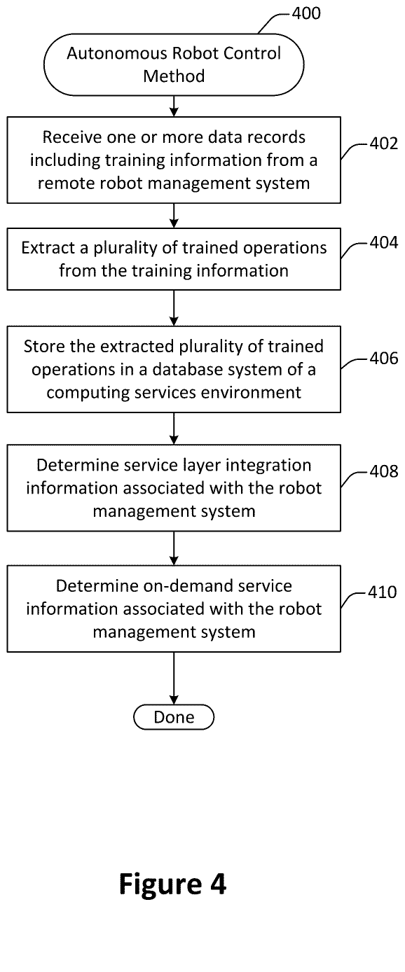

FIG. 4 illustrates an additional autonomous robot control method, performed in accordance with one or more embodiments. As similarly discussed above, training information may be received from a remote robot management system. In various embodiments, such information may be received during a remote robot onboarding process in which a remote robot is recognized as an entity within a computing services environment. Accordingly, a method, such as method 400, may be performed to implement such an onboarding process.

Method 400 may perform operation 402 during which one or more data records including training information may be received from a remote robot management system. As discussed above, the training information may be generated during one or more training sessions for a remote robot, and may include a representation of various trained operations. The data records may be transmitted from remote robot management system to one or more components of the computing services environment.

Method 400 may perform operation 404 during which a plurality of trained operations from the training information. As also discussed above, the training information may be parsed to extract various trained operations from the training information. Accordingly, the trained operations may be converted from a format native to the robot OS to a format compatible with a database system of the computing services environment.

Method 400 may perform operation 406 during which the extracted plurality of trained operations may be stored in a database system of a computing services environment. Once stored in the database system, the trained operations may be made available to various components of the computing services environment. Accordingly, training operations initially stored locally at the remote robot may be uploaded, stored, and made available to distributed on-demand applications by the database system.

Moreover, as will be discussed in greater detail below, the remote robot may also be recognizable as an entity within the computing services environment. For example, one or more data records and assets may be generated for the remote robot such that the remote robot has an identifier and may be referenced by components of the computing services environment via its associated autonomous agent instance. Accordingly, as part of an on-boarding process, a remote robot may also have associated data records generated within the computing services environment that make the remote robot discoverable and interactable to on-demand services supported by the computing services environment.

Method 400 may perform operation 408 during which service layer integration information associated with the robot management system may be determined. As similarly discussed above, such service layer integration information may include an identification of one or more service layer entities, such as Mulesoft endpoints, that may be associated with the remote robot. Such service layer entities may be entities that receive information from the remote robots, such as data uploads, as well as other entities that receive other observational data, such as status and maintenance information. In various embodiments, such service layer integration information is determined automatically based on designated default parameters or other automatic settings. In some embodiments, such service layer integration information is determined based on an input received from a user, as will be discussed in greater detail below. In various embodiments, the service layer integration information is stored in the database system.

Method 400 may perform operation 410 during which on-demand service information associated with the robot management system. In various embodiments, such on-demand service information may include an identification of on-demand service entities that may be associated with the remote robot. Such on-demand service entities may be additional entities associated with on-demand services that receive information from the remote robots. Accordingly, additional on-demand services that may be implemented by other on-demand computing platforms may also be specified and stored in the database system.

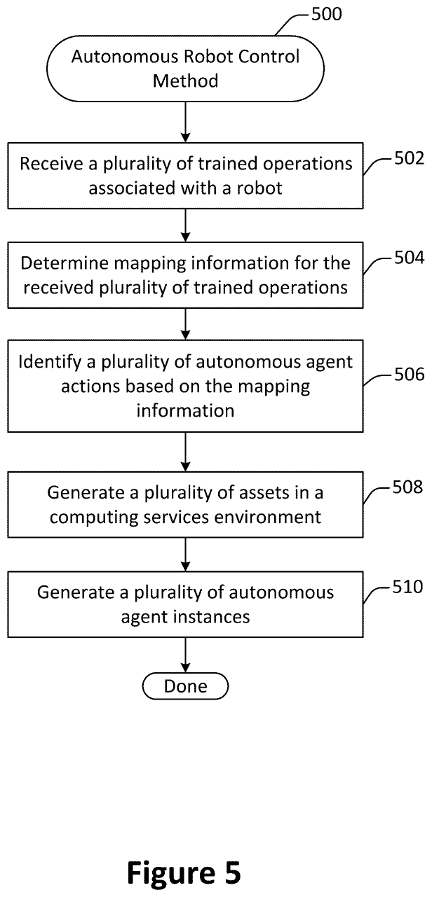

FIG. 5 illustrates another autonomous robot control method, performed in accordance with one or more embodiments. In various embodiments, in addition to on-boarding a remote robot and establishing the remote robot as a recognized entity within the computing services environment, a method, such as method 500, may be performed to generate and deploy an autonomous agent instance for the remote robot within the computing services environment.

Method 500 may perform operation 502 during which a plurality of trained operations associated with a robot may be received. As discussed above, the training information may be generated during one or more training sessions for a remote robot, and may include a representation of various trained operations. Accordingly training information may have been parsed and stored in a database system. During operation 502, trained operations may be retrieved from the database system. In another example, the training information may be received from the remote robot management system and may be parsed during operation 502.

Method 500 may perform operation 504 during which mapping information may be determined for the received plurality of trained operations. As similarly discussed above, such mapping information enables integration of the training information with the infrastructure of the autonomous agent platform, and enables the autonomous agent instance to generate command information for such trained operations. Moreover, the mapping of such trained operations to autonomous agent instance actions may be generated based on a designated mapping stored in a database system, or may be generated based on a received input.

In one example, a user may provide an input to a user interface that maps trained operations to action for the autonomous agent instance. More specifically, a user interface may be provided to a user, and may present multiple data fields configured to receive inputs for different actions. For example, such data fields may be configured to receive text inputs from the user via an input device. In some embodiments, the inputs received via the data field are provided to a large language model to facilitate natural language processing of the received text input. In this way, natural language text inputs may be provided via the data fields of the user interface, and may be used to define a mapping between trained operations and autonomous agent instance actions.

Method 500 may perform operation 506 during which a plurality of autonomous agent actions may be identified based on the mapping information. Accordingly, as similarly discussed above, the autonomous agent actions may be defined based on the mapping determined during operation 504. During operation 506, the autonomous agent actions may be defined for an autonomous agent instance that is being generated for the remote robot associated with the trained operations. Accordingly, during operation 506, the actions for the autonomous agent instance may be determined and stored for the autonomous agent instance. Moreover, topics associated with the actions may also be determined and stored. In various embodiments, a topic may be defined for a trained task, and actions may be defined for that topic that represent actions performed during the trained task. For example, a topic may be a gauge inspection, and the actions may be the actions performed in order to inspect the gauge.

Method 500 may perform operation 508 during which a plurality of assets may be generated in a computing services environment. As similarly discussed above, the remote robot may be made recognizable as an entity within the computing services environment. For example, one or more data records and assets may be generated for the remote robot such that the remote robot has an identifier and may be referenced by components of the computing services environment via its associated autonomous agent instance. Accordingly, the remote robot may also have associated data records generated within the computing services environment that make the remote robot discoverable and interactable to on-demand services supported by the computing services environment.

In one example, an on-demand computing service, such as Lightning Web Components provided by Salesforce.com®, may be used to generate and manage one or more operational flows. For example, Lightning Web Components may be used to generate a Lightning flow that defines operations as well as relationships between them. In some embodiments, one or more assets may be created for the remote robot that represent the remote robot as an asset associated with an organization in a customer relationship management (CRM) database. When stored and represented in this way, the asset representing the robot may be discoverable by an on-demand service, such as Visualforce, and interactions between the two may be supported, as will be discussed in greater detail below.

Method 500 may perform operation 510 during which a plurality of autonomous agent instances may be generated. Accordingly, an autonomous agent instance may be instantiated based on the received and determined information. Moreover, the autonomous agent instance may be deployed within the computing services environment. Once deployed, the autonomous agent instance may perform command information generation operations as may be appropriate for its associated robot.

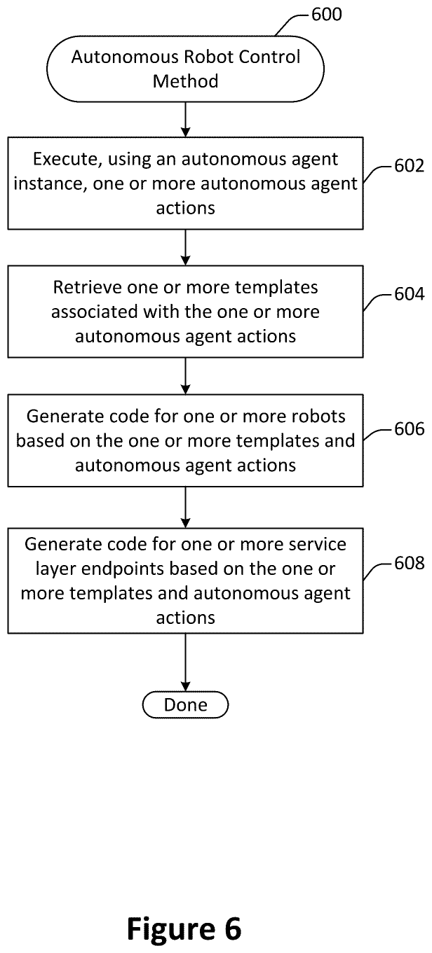

FIG. 6 illustrates an additional autonomous robot control method, performed in accordance with one or more embodiments. As similarly discussed above, autonomous agent instances may be used to generate code for associated remote robots to facilitate configuration and command of such remote robots. Accordingly, a method, such as method 600, may be performed to generate code for such robots as well as code for associated service layer endpoints.

Method 600 may perform operation 602 during which one or more autonomous agent actions may be executed. As similarly discussed above, the autonomous agent actions may have been defined for an autonomous agent instance based on training operations identified for its associated remote robot. The action to be executed may be triggered based on a received input or based on an identified operational condition or system event. For example, as part of a periodic maintenance schedule, a diagnostic operation may be performed. Accordingly, in response to the passage of a designated amount of time, the autonomous agent instance may determine one or more actions should be executed.

Method 600 may perform operation 604 during which one or more templates associated with the one or more autonomous agent actions may be retrieved. In various embodiments, a repository of code templates may be stored in a database system. Accordingly, various code templates may exist for various types of actions. Such templates may have been previously generated by an entity, such as an administrator, manufacturer, or user, and may be configured to provide general representations of structured inputs provided to the remote robot, such as particular function calls and scripts as well as additional annotations that may be used by a user reviewing the code. In various embodiments, the one or more templates may be identified based on a designated mapping of types of actions to types of templates. Accordingly, one or more parameters of an action being executed may be used to identify a template.

Method 600 may perform operation 606 during which code may be generated for one or more robots based on the one or more templates and autonomous agent actions. Accordingly, the template may be populated with specific information by the autonomous agent instance, and the specific information may include information such as identifiers of the remote robot as well as other operational information specific to the remote robot.

Method 600 may perform operation 608 during which code for one or more service layer endpoints may be generated based on the one or more templates and autonomous agent actions. Accordingly, the template may be populated with specific information by the autonomous agent instance, and the specific information may include information such as identifiers of the remote robot as well as service layer endpoint information associated with the remote robot. As similarly discussed above, the generated code may be provided to the remote robot management system, and may be deployed to the remote robot. In this way, command information may be generated for and provided to the remote robot to perform the one or more autonomous agent actions. It will be appreciated that while embodiments disclosed herein describe the use of templates, in some embodiments, no templates are used, and code is generated dynamically without the use of templates.

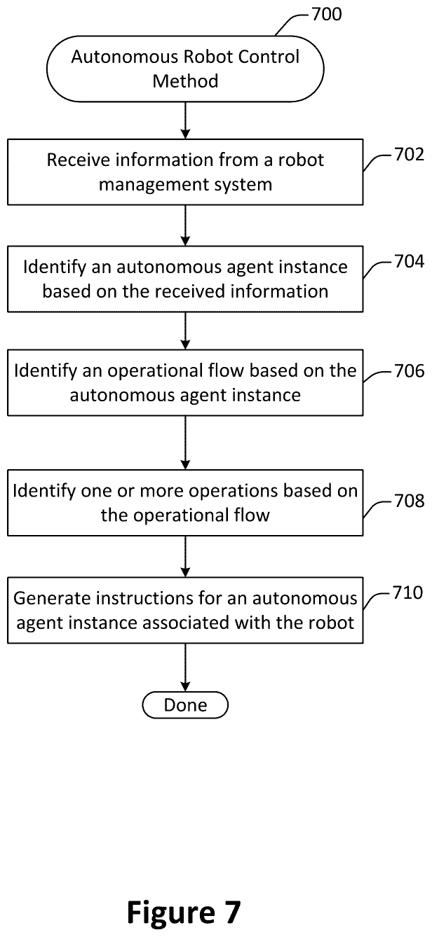

FIG. 7 illustrates another autonomous robot control method, performed in accordance with one or more embodiments. As similarly discussed above, an autonomous agent instance may interact with other on-demand services to facilitate management of a remote robot by the on-demand service via the autonomous agent instance. Accordingly, a method, such as method 700, may be performed to facilitate such remote robot management via the autonomous agent instance.

Method 700 may perform operation 702 during which information may be received from a robot management system. In various embodiments, the information may be received from a remote robot managed by a remote robot management system may be configured to transmit various information to additional entities via, for example, a service layer. In one example, such information may include status information, such as temperature readings as well as other diagnostic metrics. Such information may also include measurements and images captured from the operational environment of the remote robot.

Method 700 may perform operation 704 during which an autonomous agent instance may be identified based on the received information. As discussed above, the remote robot managed by the remote robot management system may have an associated autonomous agent instance. During operation 704, an identifier associated with the remote robot may be used to identify its associated autonomous agent instance.

Method 700 may perform operation 706 during which an operational flow may be identified based on the autonomous agent instance. Accordingly, the autonomous agent instance may identify an associated on-demand service, and may notify the associated on-demand service of the received information. As discussed above, such an associated on-demand service may be identified based on information received during autonomous agent creation, or stored the CRM database based on interactions between the on-demand service and asset records associated with the remote robot.

Method 700 may perform operation 708 during which one or more operations may be identified based on the operational flow. As similarly discussed above, the on-demand service may store one or more operational flows defining an operational flow for the remote robot. As will be discussed in greater detail below, such operational flows may be generated by an entity, such as an administrator or user to define additional operational flows capable of managing operation of the remote robot. In this way, the on-demand service provides an additional management layer for the remote robot.

Accordingly, the on-demand service may receive the information that was received at operation 702, and may determine, based on an operational flow, that an action should be taken. In one example, the operational flow may define conditions under which the remote robot should return to a repair bay for repairs. More specifically, if a temperature reading exceeds a designated value, a return for repair operation may be triggered. Accordingly, the information that was received at operation 702 may include temperature readings from on-board sensors of the remote robot. The on-demand service may determine, based on received sensor information and the operational flow, that a repair action should be taken.

Method 700 may perform operation 710 during which instructions may be generated for an autonomous agent instance associated with the robot. The on-demand service may notify the autonomous agent instance associated with the remote robot, and may also identify which actions should be taken, as may be determined based on the operational flow. The autonomous agent instance may then generate the appropriate code to send to the remote robot to perform the identified actions.

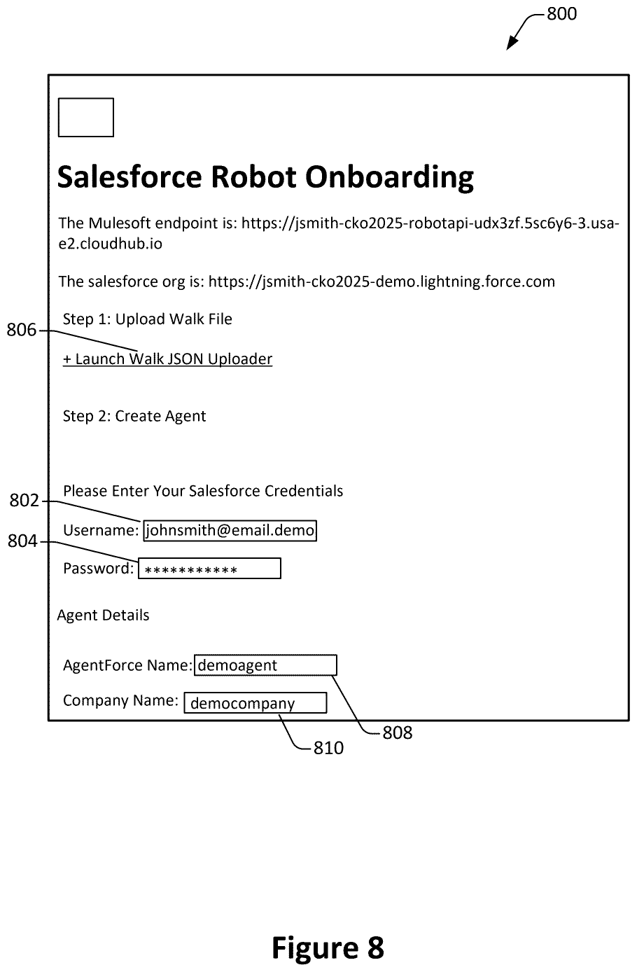

FIG. 8 illustrates a user interface for autonomous robot management, configured in accordance with one or more embodiments. As shown in image 800, a user interface is provided that includes multiple data fields configured to receive inputs from a user. More specifically, as shown in image 800, one or more data fields, such as data field 802 and data field 804, may be configured to receive inputs from a user that provide login information. Moreover, a user interface element, such as user interface element 806, may be configured to provide a link through which training information may be uploaded. More specifically, a user may provide an input, such as a mouse click, to click on the link and be provided with an additional user interface window that launches an uploader application to receive the file upload.

As discussed above, the training information may include trained operations for a remote robot, and such trained information may be stored in a format compatible with the remote robot, such as a format compatible with a robot operating system. Additional data fields are also provided for configuration of autonomous agent creation for an autonomous agent instance that will be created for the remote robot. Such additional data fields may be asset parameters that will be used to configure how the remote robot is recognized as an asset within the context of the computing services environment. For example, data field 808 may be configured to identify an agent name and data field 810 may be configured to receive an additional identifier, such as a company or organization name.

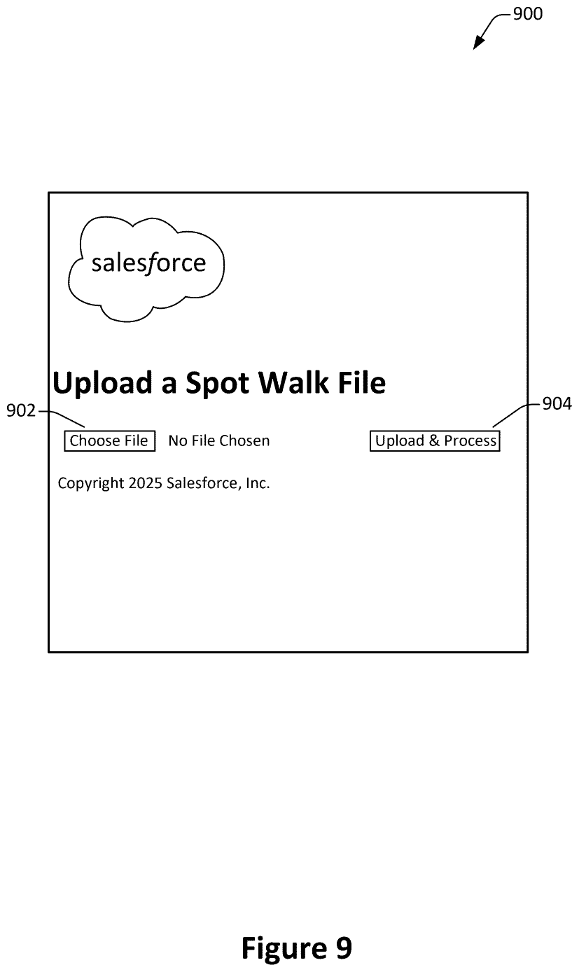

FIG. 9 illustrates a user interface for autonomous robot management, configured in accordance with one or more embodiments. As shown in image 900 of FIG. 9, one or more data fields may be included within a user interface to facilitate uploading of a training file that may be stored locally at an operational environment of a remote robot, or may be stored at any other suitable location. As similarly discussed above, the training file may have originally been generated during training of a remote robot in which the robot is guided through designated operations in a supervised manner. Once selected, the training file may be uploaded and processed in accordance with the parsing operations discussed above. Accordingly, user interface element 902 may be configured to receive an input to select a file location for a training file to be uploaded. Moreover, user interface element 904 may be configured to receive an input to initiate the upload and parsing of the training file.

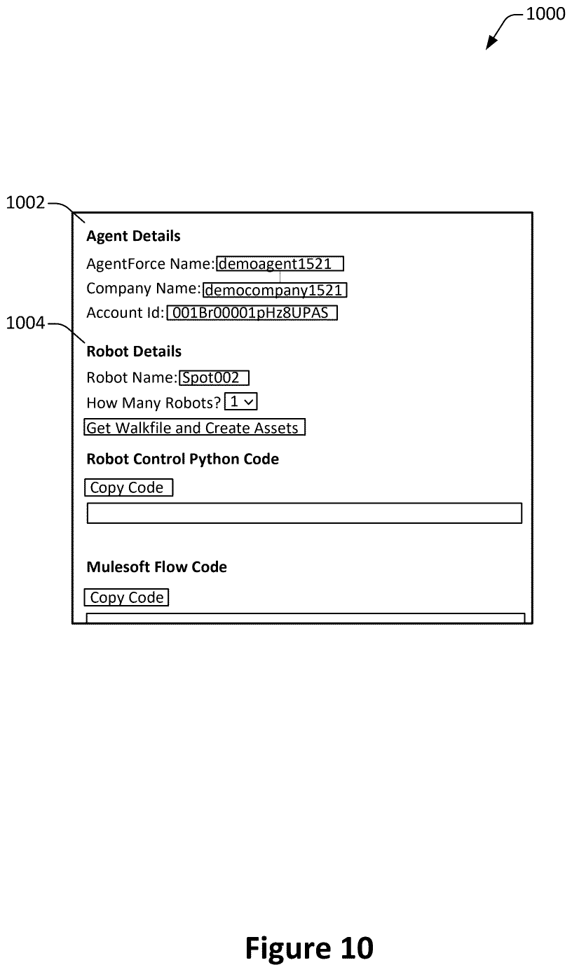

FIG. 10 illustrates a user interface for autonomous robot management, configured in accordance with one or more embodiments. As shown in image 1000, various parameters of an autonomous agent may be configured, such as an agent name, and details of associated robots may also be configured, such as the name of the remote robot to be associated with the autonomous agent as well as a number of remote robots being onboarded. More specifically, one or more data fields, such as data fields 1002, may be configured to receive inputs to configure names and properties associated with an agent instance, and data fields 1004 may be configure to receive inputs to configure names and properties associated with remote robots that are associated with and managed by the agent instance. Accordingly, a unified user interface may be provided that facilitates configuration of both the asset record(s) associated with each remote robot as well as each autonomous agent instance that is implemented for each remote robot.

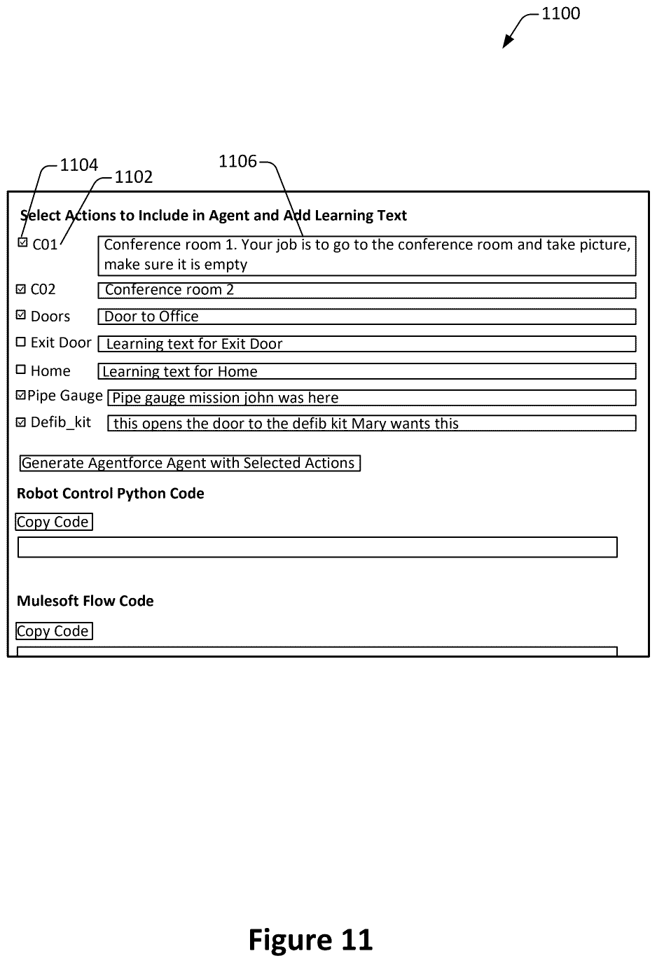

FIG. 11 illustrates a user interface for autonomous robot management, configured in accordance with one or more embodiments. As shown in image 1100, training operations that were parsed from the training information may be represented in separate selectable fields as selectable actions for the autonomous agent instance being configured. Accordingly, the data fields included in image 1100 may be populated dynamically and in response to the information parsed from the training information. For example, data fields, such as data field 1102, may display one or more identifiers for a given trained operation. In some embodiments, such an identifier may be obtained from a label generated during the training of the operation. In this way, the list of selectable actions included in the user interface may be dynamically generated based on the parsed information.

In various embodiments, different corresponding topics and actions may be selected via an input received at a user interface element, such as user interface element 1104. Inputs may include a click provided to a check box, and may be used to assign those topics and actions to the autonomous agent instance. Moreover, one or more data fields, such as data field 1106, may be configured to receive additional types of inputs. For example, data field 1106 may include a text field that is configured to receive a natural language input. As shown in FIG. 11, a natural language input has been provided that includes a command for an action to be taken by the remote robot at a particular location.

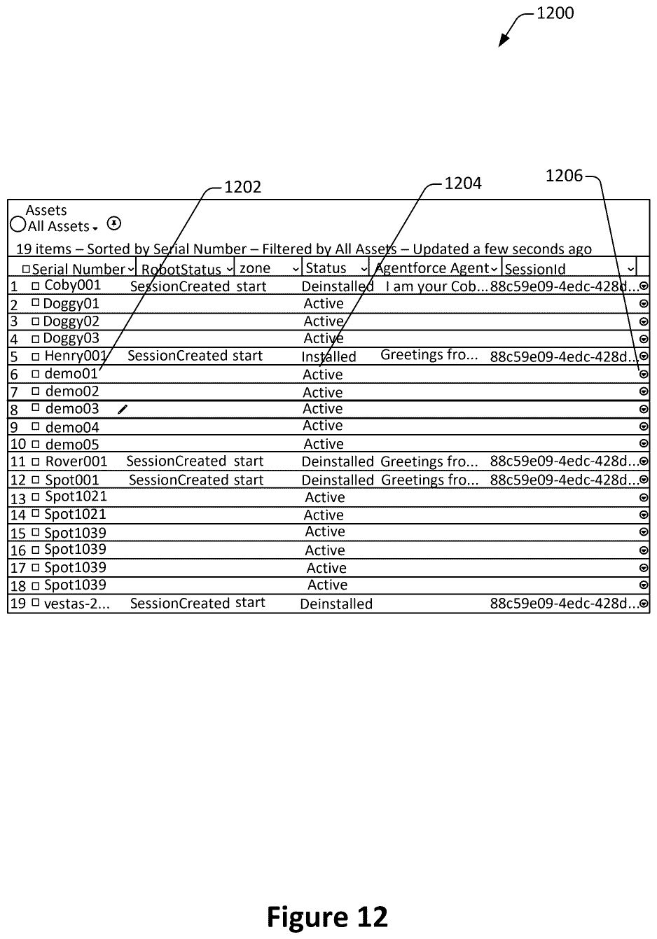

FIG. 12 illustrates a user interface for autonomous robot management, configured in accordance with one or more embodiments. As shown in image 1200, various data records may be created in a database system associated with the autonomous agent instance. In this example, an asset record has been created for each remote robot associated with the autonomous agent instance thus on-boarding the robots and making them discoverable as entities within a CRM system coupled to the database system. In one example, the user interface shown in image 1200 illustrates a list of user interface elements, such as user interface element 1202, for each asset record where such user interface elements display various information for the asset records, such as status information 1204, additional identifiers, and additional user interface elements such as expandable menu 1206 for additional views and options associated with the asset records. In this way, a unified view of asset records is provided that facilitates management of the agent instances, remote robots, and asset records.

It will be appreciated that once on-boarded, the asset record may be discoverable and interactable with other entities associated with the computing services environment. More specifically, other on-demand applications and services may discover the remote robot and exchange information with the remote robot as though the remote robot were an entity implemented within the computing services environment, and also within a domain of the on-demand application or service.

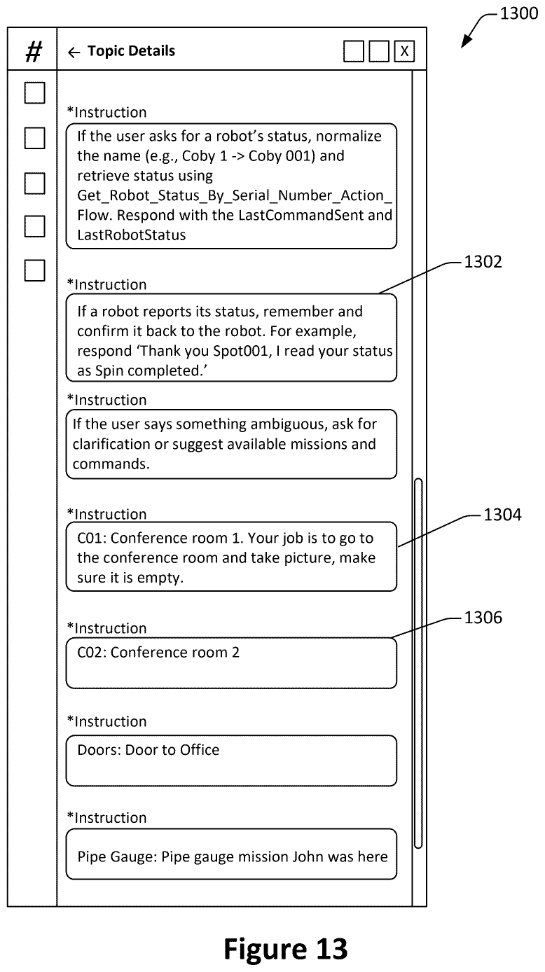

FIG. 13 illustrates a user interface for autonomous robot management, configured in accordance with one or more embodiments. As shown in image 1300, a history of commands and instructions handled by the autonomous agent instance may be displayed as a chat history in a conversational interface that may be a chat window. In various embodiments, such a conversational interface may be provided by one or more components of an agent platform. In one example, the agent platform may be Agentforce provided by Salesforce.com. Such a conversational interface may be accessible by a user to provide the user with visibility of actions taken by the autonomous agent instance. In some embodiments, the conversational interface may also be configured to receive one or more inputs from a client machine associated with a user. Accordingly, an input may be received from a client machine that provides one or more commands or other natural language inputs, such as a query. In this way, the history of commands and operations may also be interacted with dynamically to provide the ability to supervise and intervene with operations that are being performed autonomously by the autonomous agent instance.

As shown in the user interface of image 1300, commands and instructions may be derived from various different sources and may be represented within a same historical listing of commands. In one example, instruction 1302 was determined based on one or more defined actions for an agent instance. For example, a conditional set of operations may have been defined during autonomous agent instance configuration and instantiation. Moreover, instruction 1304 may have been determined based, at least in part, on a natural language input provided by a user. Additionally, instruction 1306 may have been determined based on and identification of one or more trained operations that have been defined as actions for an agent instance. A unified view of these different types of instructions may be presented within the user interface shown in image 1300.

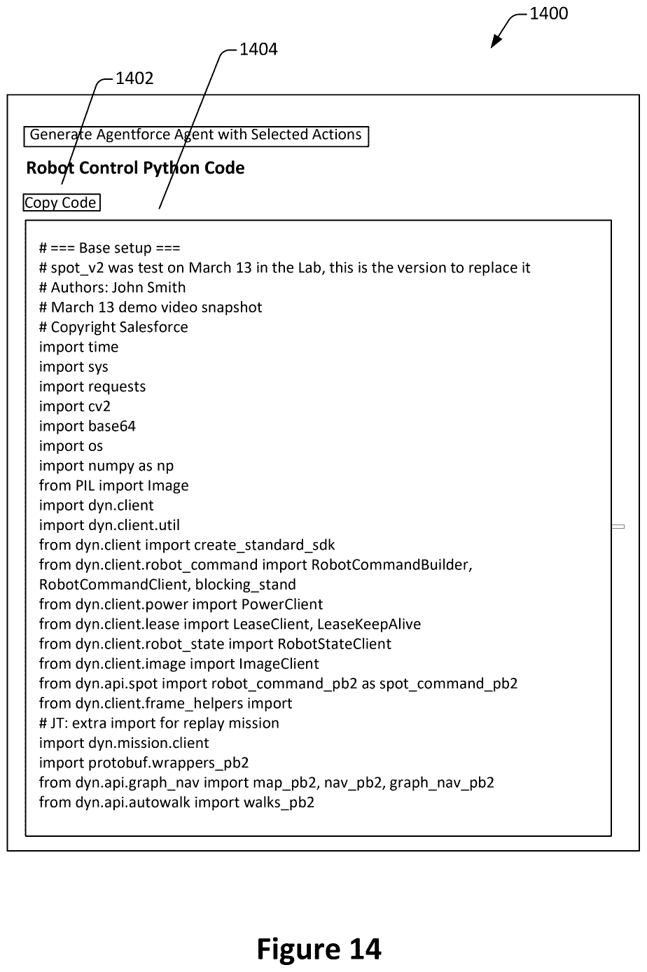

FIG. 14 illustrates a user interface for autonomous robot management, configured in accordance with one or more embodiments. As previously discussed, code may be generated to provide command information for the remote robot. Accordingly, image 1400 illustrates an example of Python code that may be generated for the remote robot by an autonomous agent instance. More specifically, user interface element 1402 may be provided that also enables manual copying and pasting of the code to facilitate code deployment to the remote robot. It will be appreciated that, in some embodiments, user interface element 1402 is configured to support additional export functionalities. For example, user interface element 1402 may be configured to receive an input, and upload the generated code to a remote robot in response to receiving the input. As also shown in image 1400, data field 1404 may be configured to show the code that has been generated.

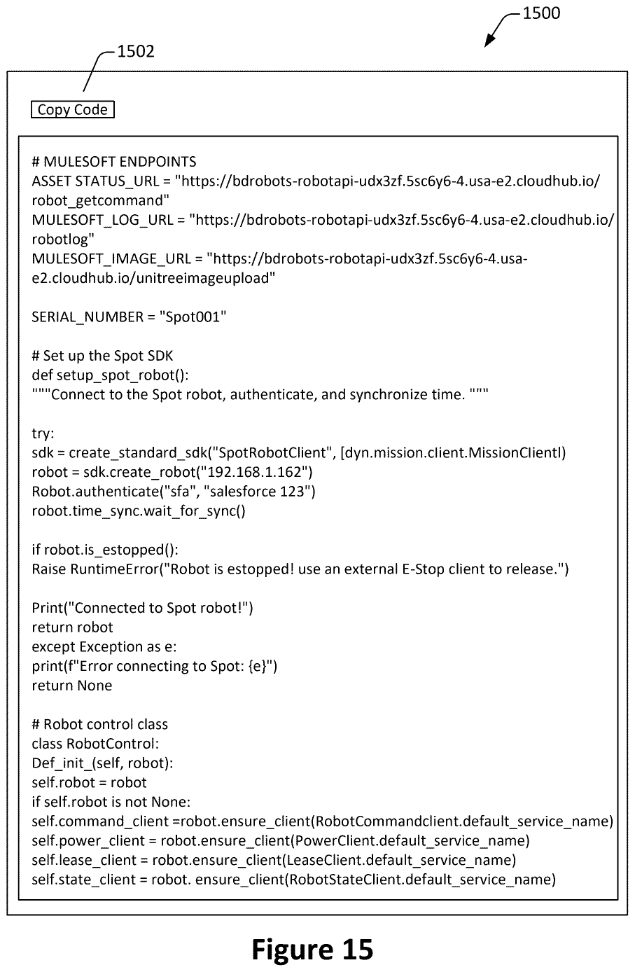

FIG. 15 illustrates a user interface for autonomous robot management, configured in accordance with one or more embodiments. Accordingly, image 1500 illustrates an additional data field that may be provided to display additional Python code generated for the remote robot. The additional Python code may include service layer integration information. For example, as shown in image 1500, Mulesoft endpoints as well as additional command information may be included in the Python code. As also discussed above, the code may be generated by the autonomous agent instance, and may also be deployed to the remote robot to configure communications and interactions between the remote robot and one or more other entities accessible via a network infrastructure of a service layer, such as Mulesoft. In various embodiments, the same user interface element discussed above with reference to FIG. 14 may be used to initiate a copy operation or an upload operation. In some embodiments, a separate user interface element, such as user interface element 1502, may be provided that is configured to initiate a copy operation and/or an upload operation of the generated code.

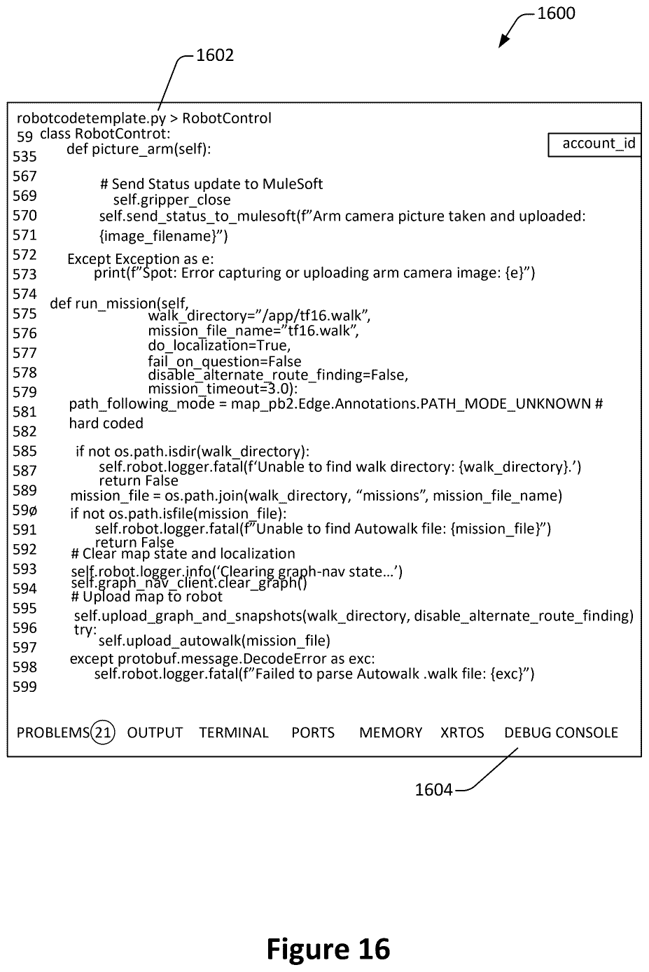

FIG. 16 illustrates a user interface for autonomous robot management, configured in accordance with one or more embodiments. As also discussed above, templates may be used to generate such code. For example, as shown in image 1600 of FIG. 16, templates may be accessible and managed via an on-demand service. More specifically, image 1600 illustrates a user interface through which templates may be accessed, added, modified, and/or removed by a user. In this way, a configurable library of templates may be stored and managed by one or more entities, such as a user or administrator. As shown in line 1602, a template has been accessed for robot control and the template may have various generic portions that may be configured and parameterized during agent instance configuration and instantiation. Moreover, the template may be provided within a user interface of a compiler that also provides various functionalities, such as debug console 1604.

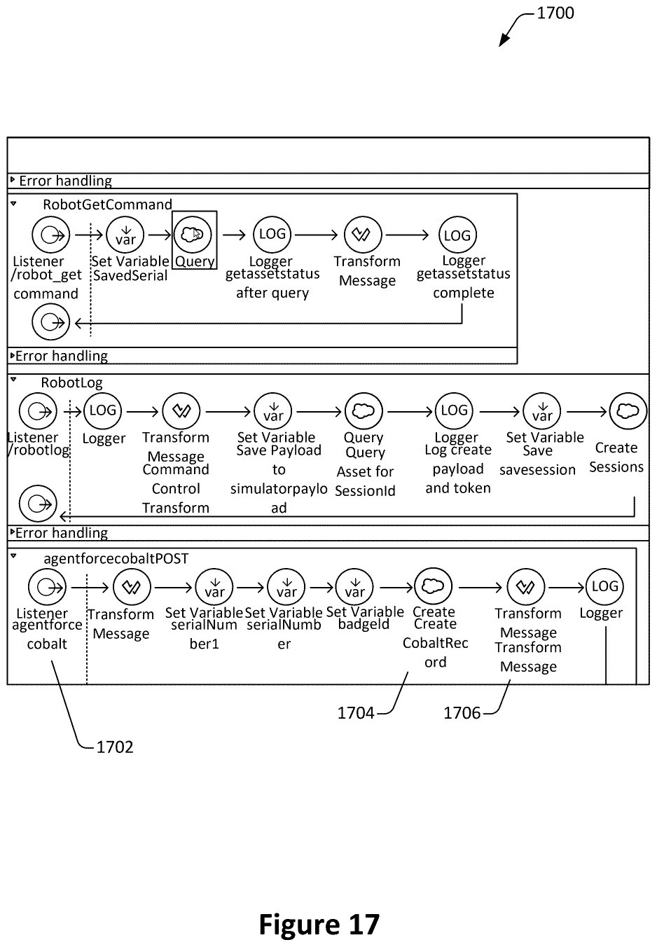

FIG. 17 illustrates a user interface for autonomous robot management, configured in accordance with one or more embodiments. As discussed above, remote robots and autonomous agent instances may interact with various other entities via components of a service layer. Accordingly, image 1700 illustrates a user interface that may be presented to a user to illustrate endpoint information currently associated with operations associated with an autonomous agent instance and its associated remote robot. More specifically, a unified view of connections of the autonomous agent instance and other entities within the computing services environment may be provided that illustrates operations included in each data path associated with and autonomous agent instance, and also illustrates an entity that may be associated with each operation. In one example, a data path may identify several operations that may be used to implement an action, such as receiving log information from a remote robot. The data path may identify operations included in such an implemented action, entities associated with each action, as well as a representation of connectivity between such entities, such as configuration of an application program interface. In various embodiments, the entities may be one or more on-demand services using the computing services environment. In various embodiments, the user interface may also provide the ability to navigate to one or more other data records associated with the other entities via a received input, such as a selection via a mouse click.

In one example, various listeners may be implemented within a service layer and may be configured to observe operations of a remote robot and/or an agent instance based, at least in part, on previously configured service layer integration information. For example, user interface element 1702 identifies a listener within the service layer. Additional operations, such as data record creation 1704 and message transformation 1706 are also identified to provide visibility for the data path associated with that listener. Moreover, each of the user interface elements may be selected to provide an additional display of information for each operation in a separate window or a pop up window. The additional information may include information underlying operations being performed as well as connectivity information identifying points of data ingress and egress.

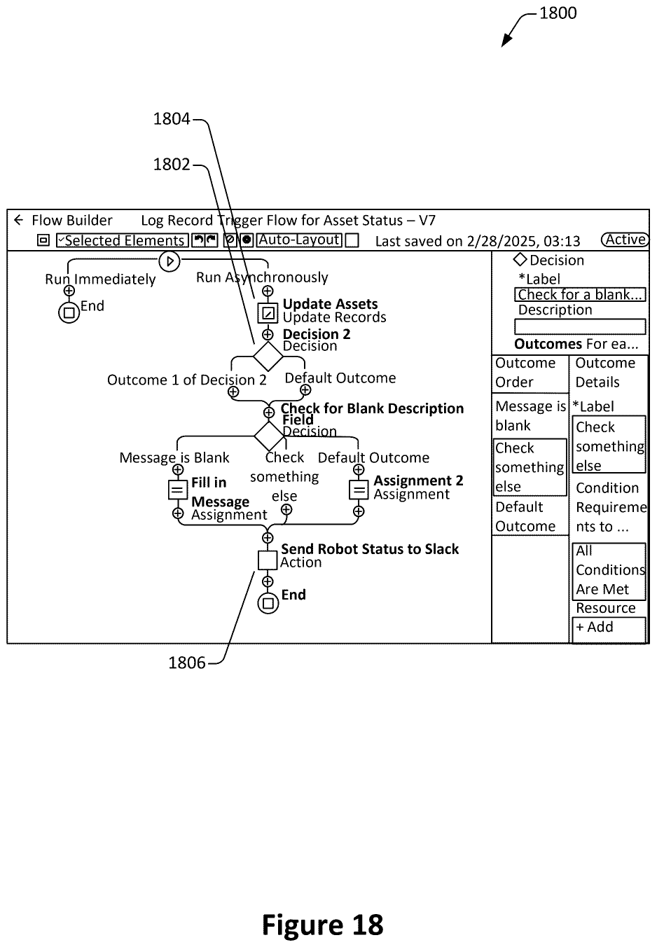

FIG. 18 illustrates a user interface for autonomous robot management, configured in accordance with one or more embodiments. As also discussed above, additional on-demand services may be configured to provide an additional management layer for autonomous agent instances and associated remote robots. Accordingly, image 1800 illustrates an example of an operational flow that may be generated and configured via a user interface. More specifically, a user may add and configure decision and operational steps, such a decision step 1802 and operational step 1804, within a flow to define parameters of what operational steps are taken under what conditions, and for which remote robots and/or associated autonomous agent instances. In one example, operation 1806 represents an operation in which an agent instance may send information associated with a remote robot to an additional on-demand service, such as Slack® provided by Salesforce.com®. Accordingly, one or more operations for the agent instance may be defined and managed via an additional operational management tool, such as Salesforce Flow Builder provided by Salesforce.com®. In various embodiments, operational flows may be stored as operational flow data that is stored and maintained by an on-demand service. For example, such an on-demand service that provides the user interface may be a flow building tool such as Salesforce Flow Builder provided by Salesforce.com®.

### AGENTIC AI OVERVIEW

Various embodiments described herein relate generally to artificial intelligence techniques. Generative AI models can be applied in a computing services environment in any of various ways. One way in which generative AI models may be applied involves integrating such models into existing applications. Such models are typically task-specific offering enhancements to core functionalities. For instance, generative AI models may be used to generate emails, service replies, work summaries, and the like. Such models are often tightly integrated into existing, task-specific applications. They often have limited autonomous and interactions driven by user interfaces. Although various details regarding autonomous agents are discussed in this application, additional details are discussed in U.S. patent application Ser. No. 19/037,321 by Kshirsagar et al., filed Jan. 27, 2025, titled Artificial Intelligence Agent Architecture in a Database System”, which is hereby incorporated by reference in its entirety and for all purposes.

According to various embodiments, as AI models became more sophisticated, they became integrated into autonomous agents. Such autonomous agents act as intelligent assistants, capable of understanding and responding to user queries in natural language. Autonomous agents can perform a range of tasks, from providing information to completing complex actions. Autonomous agents are often oriented around a conversational interface and employ an AI agent as the central intelligence. They provide for increased user autonomy and have expanded capabilities beyond task-specific functions.

Various embodiments described herein now provide for a platform that supports multiple agents. Agents may facilitate retrieval augmented generation, topic filtering, headless interfaces, and other complex features. Such agents can operate independently without a user interface, proactively identifying and executing tasks based on predefined goals or real-time data. They can integrate seamlessly with various systems and applications to optimize processes and achieve desired outcomes. Agents can support features such as proactive task initiation and execution, integration with multiple systems, continuous learning and improvement, and automation of complex workflows.

According to various embodiments, different agents may possess different capabilities and knowledge, collectively contributing to the system's overall intelligence. For example, one agent may specialize in data analysis, while another focuses on natural language processing.

In some embodiments, communication by agents can be powered by generative language models. Generative language models can facilitate seamless communication and collaboration among agents, allowing them to share information, coordinate actions, and/or make collective decisions.

In some embodiments, different agents may employ a shared context, which provides a common understanding of the environment, goals, and constraints involved in performing a task. The shared context helps to ensure that different agents can coordinate work towards a unified objective.

In some embodiments, different levels of AI models may be supported in the system. At the lowest level, embedded AI models may perform specific, predefined functions such as generating emails, service replies, work summaries, predicting outcomes based on structured data, classifying input, and the like. At the highest level, an agent can operate independently and autonomously, making decisions and taking actions based on its knowledge and the shared context. This autonomy allows the system to adapt to changing conditions and handle complex tasks. An autonomous agent can move beyond reactive responses and can proactively identify opportunities, anticipate user needs, and initiate actions without explicit prompts. Non-autonomous agents can provide a bridge between embedded AI applications and autonomous agents, facilitating the expansion of their capabilities. By understanding user interactions and preferences, non-autonomous agents can gather valuable data to refine AI models and algorithms, paving the way for greater autonomy.

As one example of an autonomous agent, consider the challenge that conventional sales pipelines are bogged down by time-consuming, inaccurate, and inefficient processes. Sellers spend excessive hours prospecting to generate leads, often employing a scattershot approach that yields low conversion rates. Techniques and mechanisms described herein provide for an autonomous agent configured as a sales development representative that works tirelessly to boost pipeline velocity. The autonomous agent rapidly prioritizes leads, grows pipelines, and reduces manual workload, providing a unified approach to sales orchestration across direct, indirect, and self-service channels.

As another example of an autonomous agent, consider the challenge that sales teams and representatives would like to improve performance and achieve sales targets. Techniques and mechanisms provide for a sales manager coach that offers real-time, data-driven performance analytics, coaching tools, recommendations, and performance metrics for both sales representatives and managers.

As another example, consider the challenges faced by many manufacturing companies, where procurement is in a silo, isolated from manufacturing and also completely disconnected from a customer relationship management system. Accordingly, many procurement organizations manually acquire parts, products, and supplies. Procurement departments are therefore often working with dated information, and are not processing real-time requests from CRM and Manufacturing. To address these problems, an autonomous agent may be configured. Consider the example of a requirement to acquire four specially built tires. Procurement sends an autonomous agent to search for the four tires and autonomously sources them if it finds them. If the autonomous agent can't find them, then it autonomously schedules a production run for the 4 tires, and reaches out to sales to notify the customer about lead time. Data connectors can gather the data sources and provide the data required to identify the available sources, capacity of the production line, and demand. Procurement can either source the part itself or source by the bill of materials. The autonomous agent in the sales dept could also communicate with procurement to procure the required materials and products. Other data sources may include information such as weather, anticipated demand for products, and/or anticipated product failures due to customer neglect (e.g., failure to perform maintenance). Thus, an autonomous agent may combine generative language models with other types of AI models, such as prediction models, a configuration referred to as “blended AI.”

More generally, according to various implementations, the models and/or modules described herein may include classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

According to various embodiments, techniques and mechanisms described herein address a variety of technical challenges, such as adapting generative language models to integrate with computing services environments. Computing services environment provide various types of computing services from a service provider to various client organizations. Examples of such services include, but are not limited to, those directed to customer relations management, sales relations management, supplier relations management, and database management applications. Autonomous agents may help to connect the power and flexibility of generative language models with the power and flexibility of computing services environments. However, existing approaches to autonomous agent configuration and implementation involve manually configuring autonomous agents to perform particular tasks. Such an approach suffers from various drawbacks, such as lack of testability, lack of extensibility, significant development delay, and more. In contrast, techniques and mechanisms described herein provide a set of architectures, frameworks, and methodologies facilitating autonomous agent development and implementation that in various embodiments are extensible, automatable, automated, flexible, and integrated with various computing services environment and generative language model platforms.

According to various embodiments, a computing services environment includes a wide variety of computing services arranged across a wide variety of computing devices in communication with one another. Likewise, a generative language model includes many neurons (e.g., millions, billions, or more) arranged in complex neural networks configured to perform sophisticated generative tasks. Coordinating between such systems involves a host of operations, including those related to processing, communication, architecture, coordination, monitoring, feedback, auditing, logging, and more. Any method performed by a system operating at the intersection of a computing services environment and a generative language model is, therefore, necessarily incapable of being performed in the human mind. In such a context, even a seemingly simple operation involves such a wide range of computing resources that a human mind would be incapable of performing the operation to within a method implemented as described herein. For example, although a human mind is capable of generating text, the human mind is incapable of executing a generative language model to generate text to complete a prompt specified in accordance with one or more embodiments.

### AGENT PLATFORM OVERVIEW

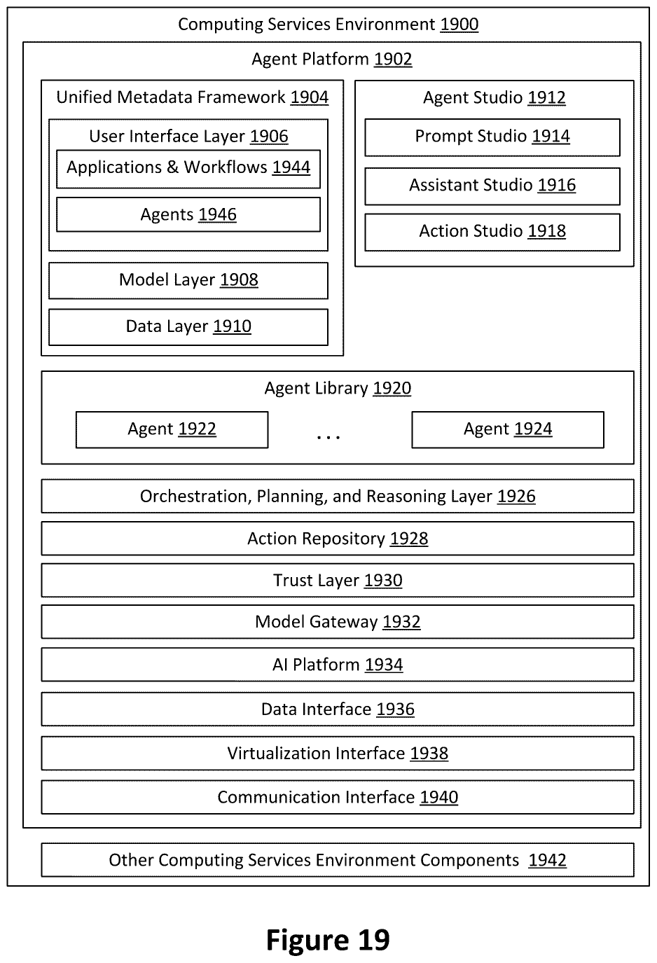

FIG. 19 illustrates a computing services environment 1900, configured in accordance with one or more embodiments. The computing services environment 1900 includes an agent platform 1902 and other computing services environment components 1942. The agent platform 1902 includes a unified metadata framework 1904, an agent studio 1912, an agent library 1920, an orchestration, planning, and reasoning layer 1926, an action repository 1928, a trust layer 1930, a model gateway 1932, an AI platform 1934, a data interface 1936, a virtualization interface 1938, and a communication interface 1940. The agent library 1920 includes the agents 1922 through 1924. The unified metadata framework 1904 includes a user interface layer 1906, a model layer 1908, and a data layer 1910. The agent studio 1912 includes a prompt studio 1914, an assistant studio 1916, and an action studio 1918.

According to various embodiments, the unified metadata framework 1904 may facilitate the configuration of agents as well as interactions between various elements of the computing services environment 1900 and the autonomous agent platform 1902. For instance, various operations, data objects, and other resources within the computing services environment 1900 may be defined as metadata entries within the unified metadata framework 1904. Agents may then be constructed using those metadata entries as building blocks.

In some embodiments, the user interface layer 1902 facilitates the specification of various applications and workflows 1944. Such applications and workflows may include operations performed within and/or outside of the computing services environment 1900. For example, applications and workflows may be specific to types of services provided via the computing services environment 1900, such as sales, service, marketing, commerce, data analysis, and the like. As another example, applications and workflows may include domain-specific operations, such as those specific to healthcare, finance, or other industries.

In some embodiments, the user interface layer 1902 facilitates the specification of agents 1946 such as conversational chat assistants. For example, the computing service environment 1900 may provide one or more standard conversational chat assistants that may be accessed through user interfaces provided via the computing services environment 1900 or via other communication channels such as email, SMS, or external chat services. As another example, an autonomous agent may be customized by, for instance, an organization accessing computing services via the computing services environment 1900.

In some embodiments, the agents 1946 may be configured to perform various tasks within the system. Examples of agents may include, but are not limited to, customized agents, coaching agents, sales development agents, and customer service agents. Agents may be represented in the unified metadata framework 1904 in the user interface layer 1906 and may be stored in the agent library 1920.

According to various embodiments, one or more of the agents may be autonomous AI agents. Autonomous AI agents (also referred to herein as autonomous agents) may be capable of autonomous or semi-autonomous activation and/or operation. However, not all AI agents are necessarily entirely autonomous. For instance, some AI agents may operate under human control and instruction, for instance eliciting human confirmation before performing some types of actions.

According to various embodiments, an agent may perform operations such as receiving user input, executing one or more applications, workflows, actions, or operations within the computing services environment 1900, and/or interacting with a database system, generative language model, other artificial intelligence models, and/or other system accessible via the computing services environment 1900.

According to various embodiments, the model layer 1904 provides for secure interaction with one or more artificial intelligence models. For instance, the model layer may define access information for performing actions such as retrieving data and accessing AI models via the trust layer 1930, the model gateway 1932, the AI platform 1934, and the data interface 1936.

According to various embodiments, the trust layer 1930 is configured to perform operations such as masking personally identifying information, securely retrieving data, detecting toxic language generated by a generative language model, and defending prompt completions against injection attacks and other attacks. Thus, the trust layer may provide additional protections for various actions performed in the context of various applications, workflows, and autonomous agents.

In some implementations, the data layer 1906 defines data retrievers providing access to data sources, which may be located inside or outside of the computing services environment 1900. Examples of such data sources may include, but are not limited to: structured data sources, unstructured data sources, data lakes, vector databases, relational databases, unified user profiles, data-based actions, data warehouses, and data lakehouses.

In some embodiments, an agent may be used to perform one or more tasks within the computing services environment 1900. For example, an autonomous agent may interactively converse with a user in natural language. As another example, an agent may interact with one or more artificial intelligence models, including one or more generative language models, one or more predictive models, one or more classification models, and/or one or more other types of models. As yet another example, an autonomous agent may retrieve information from a database system, store information to a database system, transmit one or more messages, and/or take other actions within the computing services environment 1900.

In some embodiments, the agent studio 1912 allows for the construction and customization of various aspects of the agent platform 1900 and/or agents accessible via the agent platform 1900. The agent studio 1912 may include elements such as a user interface, metadata information, monitoring, governance, and/or search tools for building agents. For example, the agent studio 1912 may provide support for constructing one or more prompts, actions, applications, workflows, or the like.

The agent studio 1912 includes a prompt studio 1914, an assistant studio 1916, and an action studio 1918. According to various embodiments, the agent studio 1912 provides functionality for the configuration of assistants, actions, and prompts to support agent platform customized for a customer organization. For example, a user may build, test, and integrate prompts, actions, and/or autonomous agents into one or more applications provided by or interoperating with the computing services environment 1900 to support the performance of various tasks for an organization.

Agents 1922 through 1924 may be stored in the agent library 1904. One or more agents may be configured in a standardized format and/or template for use by various organizations and individuals accessing computing services via the computing services environment 1900. Additionally, one or more agents may be customized for particular industries, organizations, individuals, applications, and/or other contexts.

At 1926, an orchestration, planning, and reasoning layer provides for the execution of an agent to interpret, decompose, and implement actions based on user inputs. For example, a user instruction such as “draft an email summarizing this record” may be analyzed to identify an overall intent. The user instruction may also be decomposed into actions such as “summarize a record” and “draft an email using the summary”. The decomposition and overall intent may be used to orchestrate and execute a plan, which may involve identifying the focal record, determining and completing one or more prompts to determine the summary, and determining and completing one or more prompts to draft an email using the summary. Additional details regarding the formulation and execution of such a plan are discussed throughout the application.

According to various embodiments, the action repository 1928 may include one or more actions that are preconfigured to perform tasks within the computing services environment 1900. For instance, an action repository may include actions such as “summarize a record” or “draft an email.” An autonomous agent may identify and execute such actions in order to implement a user's intent or accomplish other objectives assigned to the autonomous agent.

In some embodiments, one or more of the actions may be specific to a particular domain. For instance, one or more actions in the health or finance domains may include particular constraints, such as instructions provided to a generative language model, to provide for compliance with relevant laws and regulations.

In some embodiments, one or more of the actions may be configurable and/or user-defined. For instance, a user associated with an organization accessing computing services via the computing services environment 1900 may provide code and/or other action definition information specifying an action to be performed. The defined action may then be incorporated into an orchestration or workflow.

The model gateway 1932 provides access to one or more generative language models or other artificial intelligence models. In some embodiments, agents may be supported by a range of different generative language models. For example, a customer organization may be able to use standardized models provided by model providers such as Open AI, Microsoft Azure, Gemini, or the like. As another example, the model gateway 1932 may also support customized models, for instance models customized and/or hosted by a customer organization. As yet another example, the model gateway 1932 may provide access to models hosted within the computing service environment 1900.

In some embodiments, an AI agent may be configured to employ different models for different aspects of the agent. For example, one model (e.g., Gemini) may be used for a function such as “summarize record”, while another model (e.g., Open AI) may be used for a function such as “draft email”. In this way, an AI agent may be flexibly adapted to execute a variety of different operations.

In some embodiments, the model gateway 1932 may provide a feedback framework for receiving user feedback. The user feedback may be stored in the database and may be used for a variety of purposes, such as finetuning an autonomous agent and/or one or more of the underlying generative language models.

The AI platform 1934 may provide support for generative language models and other types of AI models hosted by the service provider of the computing services environment 1900 and/or one or more partner or customer organizations. For example, the customer organization may provide their own generative language model, such as a hosted generative language model. As another example, the customer may employ a customer-tuned version of a standard model, such as the customer's version of a model provided by Azure or Gemini. As still another example, an agent may employ a standard generative language model hosted by the service provider of the computing services environment 1900.

The data interface 1936 provides access to one or more of a variety of data sources. According to various embodiments, an agent may access one or more data sources to support the autonomous agent operations. For example, an agent may access third party data sources such as Google Cloud, Google BigQuery, Amazon S3, or Microsoft Azure. As another example, an agent may access one or more data sources from inside the computing services environment, such as customer relations management data. As still another example, an agent may access data from other sources, such as legacy systems, external apps, mobile sources, web sources, software development kids, and/or application procedure interfaces. Examples of data interfaces may include, but are not limited to: data lakehouses, real-time data services, zero-ETL data services, united profiles, data actions, data connectors, relational database systems, and any other interfaces for accessing structured, unstructured, or semi-structured data sources.

At 1938, a virtualization platform provides for the ability to deploy one or more aspects of the platform provided via the computing services environment in one or more virtual environments. For example, data residency requirements may be enforced, ensuring that data resides in a particular location. As another example, communications may be encrypted end-to-end. As still another example, one or more regulatory requirements may be enforced. The virtualization platform 1938 may allow all or a portion of the computing services environment 1900 to be deployed in a different location, such as within a hosted environment (e.g., Google Compute, Amazon AWS, etc.).

The communication interface 1940 facilitates communication with one or more client machines via any of various communication channels. For example, depending on the system configuration, a client machine may communicate with an autonomous agent via a web interface, a messaging application (e.g., Slack), email, voice, SMS messages, and/or any other suitable communication channel. Some such channels may be embedded into other applications, such as web applications accessible via the computing services environment 1900 or native applications accessed via a client machine.

According to various embodiments, as shown in the other computing services environment components 1942, the computing services environment 1900 may include various elements and components other than those shown in FIG. 19.

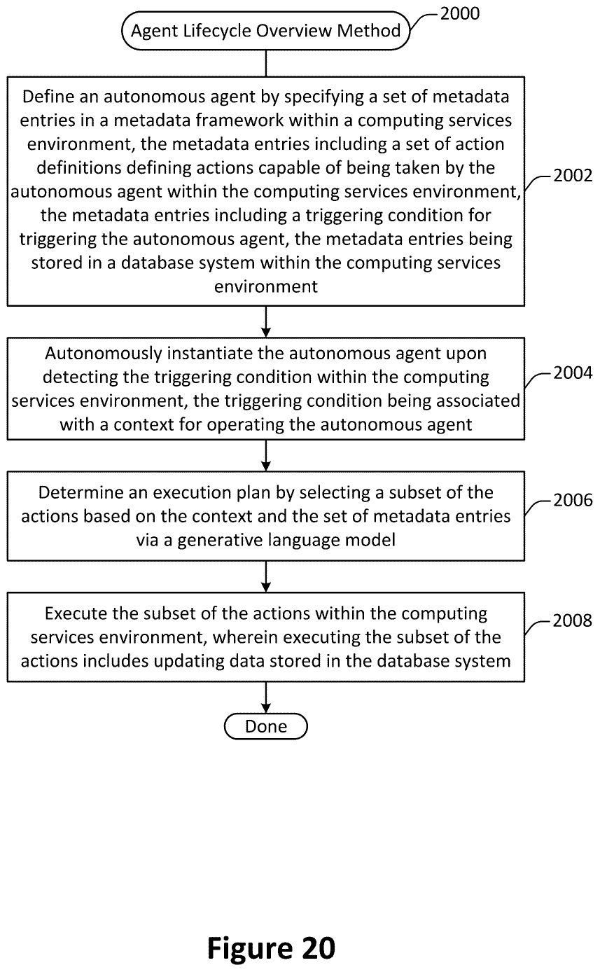

FIG. 20 illustrates a method 2000 providing an overview of the lifecycle of an autonomous agent, performed in accordance with one or more embodiments. According to various embodiments, the method 2000 may be performed at a computing services environment such as the computing services environment 1900 shown in FIG. 19.

At 2002, an autonomous agent is defined by specifying a set of metadata entries in a metadata framework within the computing services environment. The metadata entries may be stored in a database system within the computing services environment. The metadata entries may include a set of action definitions defining actions capable of being taken by the autonomous agent within the computing services environment. The metadata entries may also include a triggering condition for triggering the autonomous agent.

In some embodiments, the agent and/or one or more of the actions may be defined by the service provider of the computing services environment. Alternatively, or additionally, the agent and/or one or more of the actions may be customized by a client accessing computing services via the computing services environment. In such a configuration, the customized autonomous agent may be specific to the client and may be unavailable to other clients accessing computing services within the computing services environment.

In some embodiments, an autonomous agent may be configured for operation within a portion of the computing services environment. For instance, the autonomous agent may be configured to operate within one or more on-demand computing applications, computing clouds, chat interfaces, operational contexts, data sets, data object types, or the like.

In some embodiments, the triggering condition may include an explicit request by a user to instantiate the autonomous agent. For instance, the autonomous agent may be instantiated based on one or more natural language user instructions received via a communication channel. Alternatively, or additionally, the triggering condition may specify one or more conditions under which the autonomous agent is autonomously instantiated. For example, the autonomous agent may be instantiated automatically when a database record is created or updated with a database field value that meets one or more defined characteristics. As another example, the autonomous agent may be instantiated automatically by a workflow within the computing services environment, such as computing services environment 200. As yet another example, the autonomous agent may be instantiated upon request as part of the execution of a different autonomous agent.

The autonomous agent is autonomously instantiated at 2004 upon the detection of the triggering condition within the computing services environment. The triggering condition and hence the instantiation of the autonomous agent may be associated with a context for operating the autonomous agent. The context may specify one or more elements of an initial state of the autonomous agent. For instance, the context may identify information such as a client organization, a user account, natural language input received via a communication channel.

An execution plan is determined at 2006 by selecting a subset of the actions based on the context. The execution plan may be determined by formulating a prompt for completion by a generative language model. The prompt may include information such as a set of action descriptions and action identifiers, as well as information associated with the context such as natural language user input. The prompt may include instructions to generate text including identifiers for actions that are selected by the generative language model based on the context, the instructions, and the action descriptions.

In some embodiments, determining the execution plan may involve multiple operations, executed in sequence or in parallel. For example, a particular planner and/or agent of a set of available planners and/or agents may first be selected. As another example, a topic or topics may be selected from a set of available topics, and the actions available for selection may be first filtered to the topic or topics. Such an approach may reduce the number of action descriptions that need to be included in the plan determination prompt that is completed by the generative language model to determine the plan.

The subset of actions are executed within the computing services environment at 2008. Executing the actions may involve performing any of a variety of operations. In particular, one or more data records stored within the database system within the computing services environment may be updated. Other examples of the types of operations that may be performed may include, but are not limited to: retrieving data from inside and/or outside the computing services environment, determining novel text, updating computing services environment logging data, executing one or more artificial intelligence and/or machine learning models inside and/or outside the computing services environment, transmitting messages to communicate with client machines and/or other devices, and the like. As discussed herein, an action may potentially include any operation or operations capable of being performed within the computing services environment.

The method 2000 provides a general overview of the operations that may be performed in the lifecycle of an autonomous agent. Additional details regarding these operations, such as the creation of an autonomous agent, the instantiation of an autonomous agent, the determination of an execution plan, and the execution of the actions within an execution plan, are discussed throughout the application.

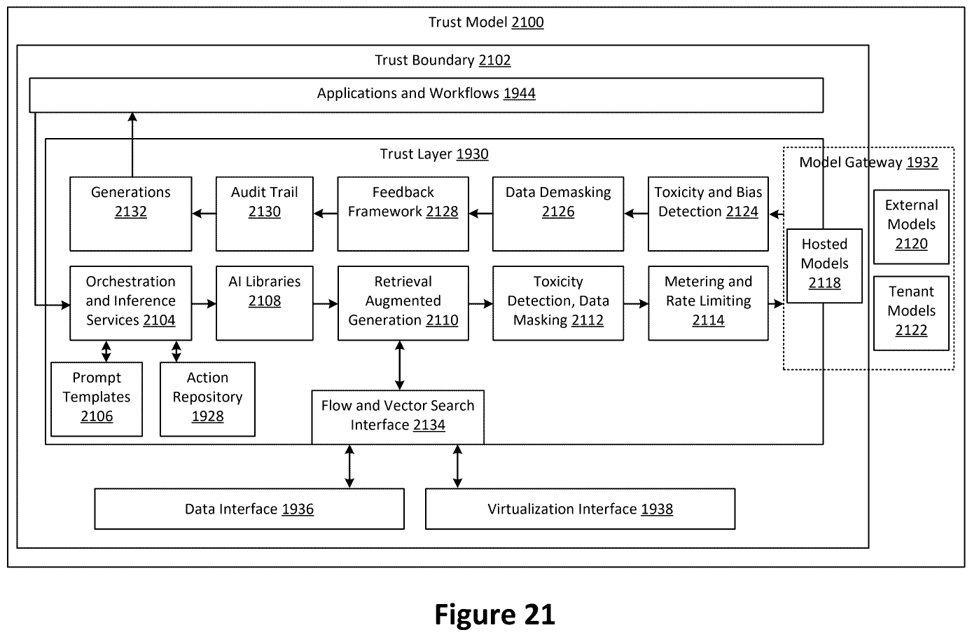

FIG. 21 illustrates a trust model 2100 for the autonomous agent platform, configured in accordance with one or more embodiments. The trust model 2100 includes a trust boundary 2102. Inside the trust boundary 2102 are the applications and workflows 1944, the trust layer 1930, the data interface 1936, and the virtualization interface 19321.

In some embodiments, the trust boundary 2102 may separate internal from external services. Inside the trust boundary, a trust layer may provide for the execution of various trust related operations. Outside the trust boundary, one or more external services or models may operate in an untrusted zone or a zone of shared trust.

The trust layer 1930 includes one or more orchestration and inference services 2104, one or more artificial intelligence libraries 2108, one or more retrieval augmented generation services 2110, one or more inbound toxicity detection and/or data masking services 2112, one or more metering and rate limiting services 2114, one or more outbound toxicity and bias detection services 2124, one or more data demasking services 2126, a feedback framework 2128, an audit trail service 2130, generations 2132, prompt templates 2106, and a one or more flow and/or vector search services 2134.

For the purpose of illustration, the trust model 2100 is shown with arrows illustrating a simple flow that may employ various components. In practice, however, the trust layer 1930 may be used to perform various types of complex operations that may operate outside the linear flow illustrated in the trust model 2100. However, the simple flow shown in FIG. 21 may be used to understand the operation and interaction of the various elements included in the trust layer 1930.

For the purpose of illustration, consider a request generated by one or more applications and workflows 1944. For instance, the request may be natural language text input provided by a user, an operation instruction triggered by an action performed in the context of an application, or some other type of request. Such a request may be sent to the orchestration and inference services 2104.

According to various embodiments, the orchestration and inference services 2104 may analyze the request to determine an intent, execute one or more actions, generate novel text, interact with the database system, receive and/or transmit one or more messages, and/or perform other types of operations. In service of performing these operations, the orchestration and inference services 2104 may access one or more prompt templates 2106, one or more actions stored in the action repository 1928, and/or other preconfigured definitions or templates.

According to various embodiments, the orchestration and inference services 2104 may transmit information to one or more artificial intelligence libraries 2108, which may trigger the retrieval of information via the one or more retrieval augmented generation services 2110. The one or more retrieval augmented generation services 2110 may retrieve information from inside and/or outside of the computing services environment via the data interface 1936 and/or the virtualization interface 1938 through the flow and/or vector search interface 2134. Retrieved information may be added to a prompt template or used to perform an action.

In some embodiments, prompts and other requests to artificial intelligence models may be processed via one or more toxicity detection and/or data masking services 2112. Toxicity detection services, bias detection services, and/or other such evaluators may seek to determine whether a request is likely to generate text or other output deemed biased, offensive, or otherwise unacceptable or impermissible. Data masking may replace some information, such as personally identifying information, with blanks, unique identifiers, or other such values.

In some implementations, requests may be further processed via one or more metering and/or rate limiting services 2114. Metering and/or rate limiting services 2114 may help to ensure that requests to models do not exceed a designated rate. For instance, one or more requests may be queued to ensure that a request rate for a designated model, user, organization, or other context does not exceed a designated threshold.

In some implementations, requests to models may be sent via the model gateway 1932. According to various embodiments, the model gateway 1932 may be used to access one or more hosted models 2118 hosted by the computing services environment 1900, one or more tenant models 2122 hosted by a customer organization, and/or one or more external models 2120 hosted by a third-party service provider. Depending on the configuration, different models may reside inside of the trust layer, outside of the trust layer, and/or in an intermediate zone such as a shared trust environment.

In some embodiments, responses from models, such as prompt completions generated by a generative language model, may be evaluated for toxicity and bias by one or more toxicity and/or bias detection services at 2124. Such evaluation may help to ensure that the system does not perform operations or return text that includes impermissible, objectionable, offensive content.

According to various embodiments, data demasking may be performed at 2126. For instance, personally identifying information in an input prompt to a generative language model may be replaced with randomly generated unique identifiers by one or more data masking services 2112. Then, when the generative language model returns a prompt completion that includes one or more of the randomly generated unique identifiers, the identifiers may be replaced with the personally identifying information. In this way, the system may generate text and/or take other actions that include or reflect personally identifying information, while at the same time not exposing such information to services outside the trust model such as externally hosted generative language models.

In some embodiments, feedback regarding actions, text generated by large language models, and/or other such operations may be determined and stored via the feedback framework 2128. Such information may be used to train models, guide subsequent actions, and/or otherwise refine the operations of an autonomous agent.

In some implementations, the audit trail service 2130 may aggregate and store information used to provide a record of actions taken by the system in the course of executing operations associated with an autonomous agent. Such information may be stored in a database system accessible via the computing services environment 1900.

In some embodiments, text and other output generated as part of the processing of requests from the requests and workflows 1908 may be returned to the applications and workflows 1908 as generations at 2132. Generations 2132 may include, but are not limited to: text to be presented in a chat interface, instructions regarding actions to be performed in the context of providing an application or workflow, or other such information.

In some implementations, generations may be extracted from novel text generated by a generative language model. For instance, a generative language model may be provided with a prompt that includes information such as: (1) one or more natural language instructions to be executed by the generative language model, (2) input data to be used by the generative language model as needed in the course of executing the one or more natural language instructions, (3) one or more parameters governing the execution of the one or more natural language instructions, (4) any other information. The input data may include text data, structured data, unstructured data, or any other type of data. The generative language model may then execute the one or more natural language instructions to generate novel text.

In some embodiments, the novel text may include natural language, such as natural language to include in a message to a user, a field in a database record, a computing services environment log, or the like. Alternatively, or additionally, the novel text may include data, such as numerical data to use in updating a database record, data indicating a selection of one or more computing resources and elements within the computing services environment. For example, computing resources and elements such as topics, actions, computing devices, clients, users, and more may be associated with corresponding unique identifiers. The generative language model may generate novel text that includes such unique identifiers. The unique identifiers may then be extracted from the novel text by the computing services environment and used to trigger and/or inform the performance of operations within the computing services environment.

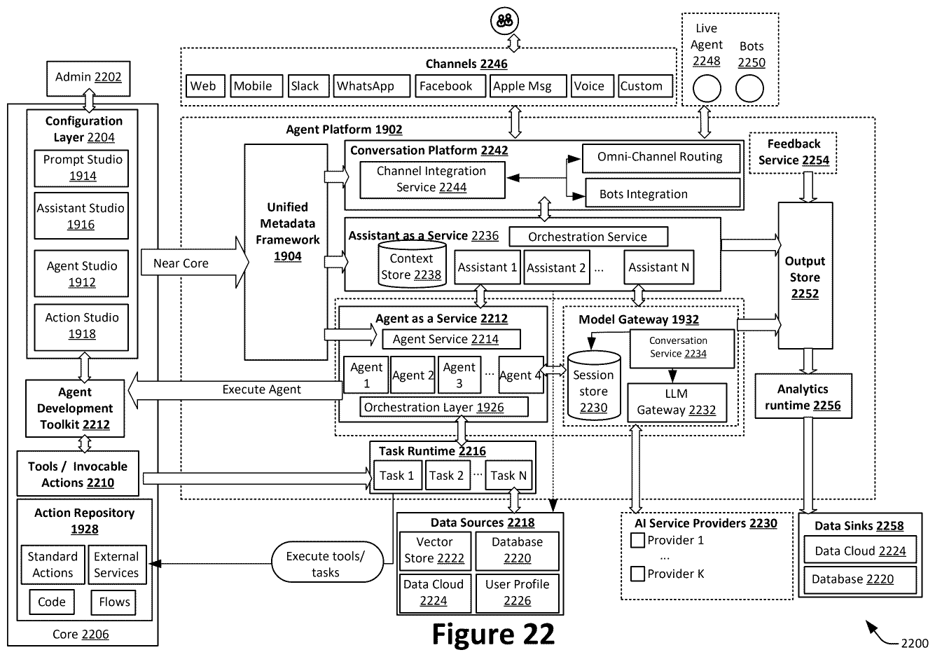

FIG. 22 illustrates an architecture diagram 2200 of elements of the computing services environment 1900, configured in accordance with one or more embodiments. The architecture diagram 2200 is provided to illustrate additional details related to the operation of the computing services environment 1900 with respect to the agent platform 1902.

In the architecture diagram 2200, an administrator 2202 or other user interacts with an agent configuration layer 2204 within the core 2206 of the computing services environment. The configuration layer includes various elements, discussed in FIG. 19, for configuring agents. Collectively these tools provide access to an agent development toolkit 2212 for defining and configuring tools and invocable actions 2210 within the computing services environment. An agent may be composed of metadata references to such tools and invocable actions 2210, as well as other metadata entries.

According to various embodiments, metadata entries may be specified within the unified metadata framework 1904 within the agent platform 1902. The metadata entries may be used to specify actions and operations associated with elements within the agent platform 1902 used to provide the agents.

In some implementations, as a central element, the agent as a service platform 2212 provides for the instantiation and execution of agents via the agent service 2214. The orchestration layer 1926 may be used to perform operations such as selecting agents, selecting planners, and determining plans. When an agent performs an action, the action may be implemented as a task executed by the task runtime 2216.

In some embodiments, executing a task may involve retrieving data from one or more of the data sources 2218. The data sources 2218 may include a variety of data sources inside and/or outside of the computing services environment 1900, including the database system 2220, a vector store 2222, a data cloud 2224 providing access to, for instance, unstructured data, and user profiles 2226.

In some embodiments, as another central element, the agent as a service platform 2212 may coordinate with the model gateway 1928 to communicate with generative language models and/or other artificial intelligence and/or machine learning models. The conversation service 2234 may coordinate the generation of natural language text via the LLM gateway 2232. The service platform 2212 may communicate with AI service providers 2230, which may be located inside or outside of the computing services environment 1900.

According to various embodiments, as a particular kind of agent, conversational chat assistants may be accessed via the assistant as a service platform 2236. Information pertaining to instances of conversational chat assistants may be stored in the context store 2238. For instance, records of conversations as well as other supporting metadata may be used to save the state of a conversational chat assistant and then restore the state at a later point in time. A conversational chat assistant orchestration service 2240 may coordinate operations of conversational chat assistants, including communication via the conversation platform 2242. The conversation platform 2242 may coordinate communication via various communication channels 2246 via a channel integration service 2244. Any of a variety of communication channels may be supported, including custom channels defined by customer organizations of the computing services environment 1900. The conversation platform 2242 may also support agent interactions with human agents 2248 and/or computing programs 2250 located outside of the agent platform 1902.

According to various embodiments, information determined by the agents may be stored to an output store 2252. Feedback regarding agent performance may be provided via a feedback service 2254, and information analyzed via an analytics runtime 2256 may be stored to one or more data sinks 2258, such as the database system 2220 and/or the data cloud 2224.

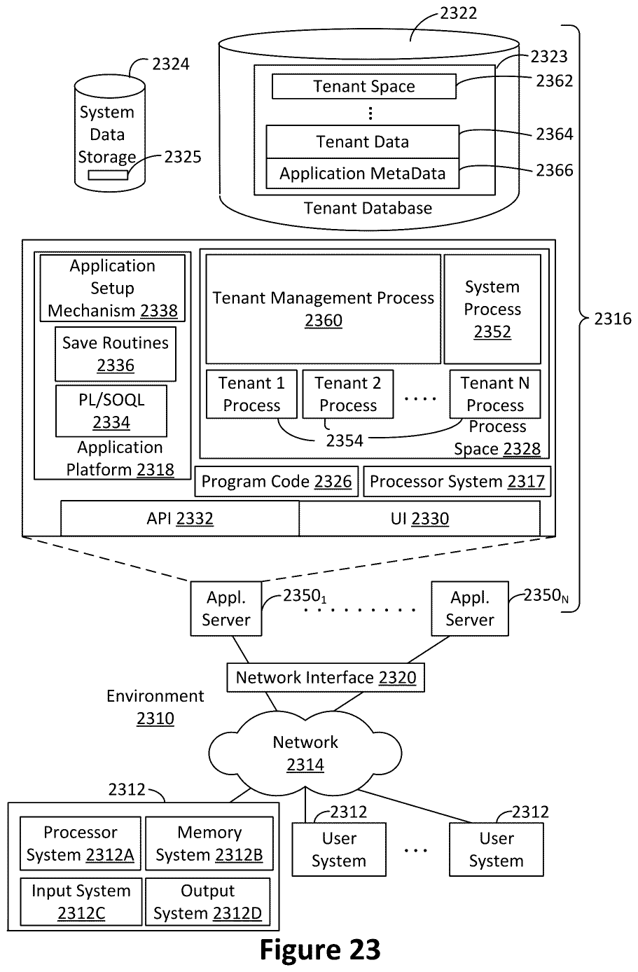

FIG. 23 shows a block diagram of an example of an environment 2310 that includes an on-demand database service configured in accordance with some implementations. Environment 2310 may include user systems 2312, network 2314, database system 2316, processor system 2317, application platform 2318, network interface 2320, tenant data storage 2322, tenant data 2323, system data storage 2324, system data 2325, program code 2326, process space 2328, User Interface (UI) 2330, Application Program Interface (API) 2332, PL/SOQL 2334, save routines 2336, application setup mechanism 2338, application servers 2350-1 through 2350-N, system process space 2352, tenant process spaces 2354, tenant management process space 2360, tenant storage space 2362, user storage 2364, and application metadata 2366. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

According to various embodiments, the environment 2310 may provide access to an agent platform. As shown in FIG. 23, the environment 2310 may also include other elements beyond the agent platform, such as computing components used to provide other types of computing services. Agents accessible via the agent platform may interoperate with such computing services. For instance, agents may trigger, configure, be triggered by, and/or accessed via such computing services.

An on-demand database service, implemented using system 2316, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 2318 may be a framework that allows the creation, management, and execution of applications in system 2316. Such applications may be developed by the database service provider or by users or third-party application developers accessing the service. Application platform 2318 includes an application setup mechanism 2338 that supports application developers'creation and management of applications, which may be saved as metadata into tenant data storage 2322 by save routines 2336 for execution by subscribers as one or more tenant process spaces 2354 managed by tenant management process 2360 for example. Invocations to such applications may be coded using PL/SOQL 2334 that provides a programming language style interface extension to API 2332. A detailed description of some PL/SOQL language implementations is discussed in commonly assigned U.S. Pat. No. 10,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 2366 for a subscriber making such an invocation. Such system processes may also manage execution of application metadata 2366 as an application in a virtual machine.

In some implementations, each application server 2350 may handle requests for any user associated with any organization. A load balancing function (e.g., an F5 Big-IP load balancer) may distribute requests to the application servers 2350 based on an algorithm such as least-connections, round robin, observed response time, etc. Each application server 2350 may be configured to communicate with tenant data storage 2322 and the tenant data 2323 therein, and system data storage 2324 and the system data 2325 therein to serve requests of user systems 2312. The tenant data 2323 may be divided into individual tenant storage spaces 2362, which can be either a physical arrangement and/or a logical arrangement of data. Within each tenant storage space 2362, user storage 2364 and application metadata 2366 may be similarly allocated for each user. For example, a copy of a user's most recently used (MRU) items might be stored to user storage 2364. Similarly, a copy of MRU items for an entire tenant organization may be stored to tenant storage space 2362. A UI 2330 provides a user interface and an API 2332 provides an application programming interface to system 2316 resident processes to users and/or developers at user systems 2312.

System 2316 may implement a web-based generative language model system. For example, in some implementations, system 2316 may include application servers configured to implement and execute generative language model software applications. The application servers may be configured to provide related data, code, forms, web pages and other information to and from user systems 2312. Additionally, the application servers may be configured to store information to, and retrieve information from a database system. Such information may include related data, objects, and/or Webpage content. With a multi-tenant system, data for multiple tenants may be stored in the same physical database object in tenant data storage 2322, however, tenant data may be arranged in the storage medium(s) of tenant data storage 2322 so that data of one tenant is kept logically separate from that of other tenants. In such a scheme, one tenant may not access another tenant's data, unless such data is expressly shared.

Several elements in the system shown in FIG. 23 include conventional, well-known elements that are explained only briefly here. For example, user system 2312 may include processor system 2312A, memory system 2312B, input system 2312C, and output system 2312D. A user system 2312 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 2312 to access, process and view information, pages and applications available from system 2316 over network 2314. Network 2314 may be any network or combination of networks of devices that communicate with one another, such as any one or any combination of a LAN (local area network), WAN (wide area network), wireless network, or other appropriate configuration.

The users of user systems 2312 may differ in their respective capacities, and the capacity of a particular user system 2312 to access information may be determined at least in part by “permissions” of the particular user system 2312. As discussed herein, permissions generally govern access to computing resources such as data objects, components, and other entities of a computing system, such as a generative language model platform, a social networking system, and/or a CRM database system. “Permission sets” generally refer to groups of permissions that may be assigned to users of such a computing environment. For instance, the assignments of users and permission sets may be stored in one or more databases of System 2316. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 2316 may provide on-demand database service to user systems 2312 using an MTS arrangement. By way of example, one tenant organization may be a company that employs a sales force where each salesperson uses system 2316 to manage their sales process. Thus, a user in such an organization may maintain contact data, leads data, customer follow-up data, performance data, goals and progress data, etc., all applicable to that user's personal sales process (e.g., in tenant data storage 2322). In this arrangement, a user may manage his or her sales efforts and cycles from a variety of devices, since relevant data and applications to interact with (e.g., access, view, modify, report, transmit, calculate, etc.) such data may be maintained and accessed by any user system 2312 having network access.

When implemented in an MTS arrangement, system 2316 may separate and share data between users and at the organization-level in a variety of manners. For example, for certain types of data each user's data might be separate from other users'data regardless of the organization employing such users. Other data may be organization-wide data, which is shared or accessible by several users or potentially all users form a given tenant organization. Thus, some data structures managed by system 2316 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 2316 may also maintain system-level data usable by multiple tenants or other data. Such system-level data may include industry reports, news, postings, and the like that are sharable between tenant organizations.

In some implementations, user systems 2312 may be client systems communicating with application servers 2350 to request and update system-level and tenant-level data from system 2316. By way of example, user systems 2312 may send one or more queries requesting data of a database maintained in tenant data storage 2322 and/or system data storage 2324. An application server 2350 of system 2316 may automatically generate one or more SQL statements (e.g., one or more SQL queries) that are designed to access the requested data. System data storage 2324 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 10,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

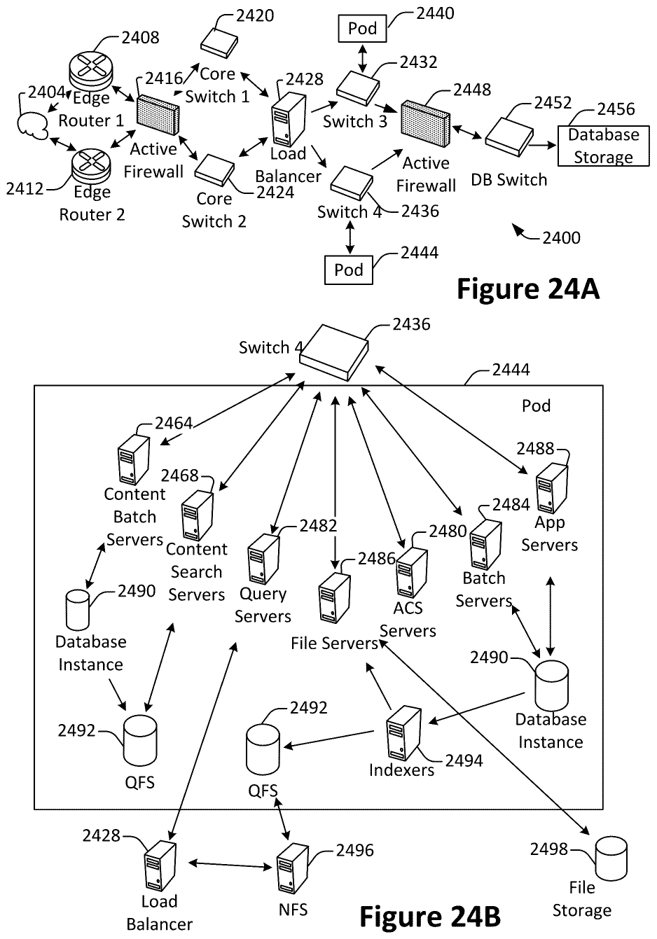

FIG. 24A shows a system diagram of an example of architectural components of an on-demand database service environment 2400, configured in accordance with some implementations. A client machine located in the cloud 2404 may communicate with the on-demand database service environment via one or more edge routers 2408 and 2412. A client machine may include any of the examples of user systems 1012 described above. The edge routers 2408 and 2412 may communicate with one or more core switches 2420 and 2424 via firewall 2416. The core switches may communicate with a load balancer 2428, which may distribute server load over different pods, such as the pods 2440 and 2444 by communication via pod switches 2432 and 2436. The pods 2440 and 2444, which may each include one or more servers and/or other computing resources, may perform data processing and other operations used to provide on-demand services. Components of the environment may communicate with a database storage 2456 via a database firewall 2448 and a database switch 2452.

Accessing an on-demand database service environment may involve communications transmitted among a variety of different components. The environment 2400 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 24A and 24B.

The cloud 2404 refers to any suitable data network or combination of data networks, which may include the Internet. Client machines located in the cloud 2404 may communicate with the on-demand database service environment 2400 to access services provided by the on-demand database service environment 2400. By way of example, client machines may access the on-demand database service environment 2400 to retrieve, store, edit, and/or process generative language model information.

In some implementations, the edge routers 2408 and 2412 route packets between the cloud 2404 and other components of the on-demand database service environment 2400. The edge routers 2408 and 2412 may employ the Border Gateway Protocol (BGP). The edge routers 2408 and 2412 may maintain a table of IP networks or ‘prefixes’, which designate network reachability among autonomous systems on the internet.

In one or more implementations, the firewall 2416 may protect the inner components of the environment 2400 from internet traffic. The firewall 2416 may block, permit, or deny access to the inner components of the on-demand database service environment 2400 based upon a set of rules and/or other criteria. The firewall 2416 may act as one or more of a packet filter, an application gateway, a stateful filter, a proxy server, or any other type of firewall.

In some implementations, the core switches 2420 and 2424 may be high-capacity switches that transfer packets within the environment 2400. The core switches 2420 and 2424 may be configured as network bridges that quickly route data between different components within the on-demand database service environment. The use of two or more core switches 2420 and 2424 may provide redundancy and/or reduced latency.

In some implementations, communication between the pods 2440 and 2444 may be conducted via the pod switches 2432 and 2436. The pod switches 2432 and 2436 may facilitate communication between the pods 2440 and 2444 and client machines, for example via core switches 2420 and 2424. Also or alternatively, the pod switches 2432 and 2436 may facilitate communication between the pods 2440 and 2444 and the database storage 2456. The load balancer 2428 may distribute workload between the pods, which may assist in improving the use of resources, increasing throughput, reducing response times, and/or reducing overhead. The load balancer 2428 may include multilayer switches to analyze and forward traffic.

In some implementations, access to the database storage 2456 may be guarded by a database firewall 2448, which may act as a computer application firewall operating at the database application layer of a protocol stack. The database firewall 2448 may protect the database storage 2456 from application attacks such as structure query language (SQL) injection, database rootkits, and unauthorized information disclosure. The database firewall 2448 may include a host using one or more forms of reverse proxy services to proxy traffic before passing it to a gateway router and/or may inspect the contents of database traffic and block certain content or database requests. The database firewall 2448 may work on the SQL application level atop the TCP/IP stack, managing applications'connection to the database or SQL management interfaces as well as intercepting and enforcing packets traveling to or from a database network or application interface.

In some implementations, the database storage 2456 may be an on-demand database system shared by many different organizations. The on-demand database service may employ a single-tenant approach, a multi-tenant approach, a virtualized approach, or any other type of database approach. Communication with the database storage 2456 may be conducted via the database switch 2452. The database storage 2456 may include various software components for handling database queries. Accordingly, the database switch 2452 may direct database queries transmitted by other components of the environment (e.g., the pods 2440 and 2444) to the correct components within the database storage 2456.

FIG. 24B shows a system diagram further illustrating an example of architectural components of an on-demand database service environment, in accordance with some implementations. The pod 2444 may be used to render services to user(s) of the on-demand database service environment 2400. The pod 2444 may include one or more content batch servers 2464, content search servers 2468, query servers 2482, file servers 2486, access control system (ACS) servers 2480, batch servers 2484, and app servers 2488. Also, the pod 2444 may include database instances 2490, quick file systems (QFS) 2492, and indexers 2494. Some or all communication between the servers in the pod 2444 may be transmitted via the switch 2436.

In some implementations, the app servers 2488 may include a framework dedicated to the execution of procedures (e.g., programs, routines, scripts) for supporting the construction of applications provided by the on-demand database service environment 2400 via the pod 2444. One or more instances of the app server 2488 may be configured to execute all or a portion of the operations of the services described herein.

In some implementations, as discussed above, the pod 2444 may include one or more database instances 2490. A database instance 2490 may be configured as an MTS in which different organizations share access to the same database, using the techniques described above. Database information may be transmitted to the indexer 2494, which may provide an index of information available in the database 2490 to file servers 2486. The QFS 2492 or other suitable filesystem may serve as a rapid-access file system for storing and accessing information available within the pod 2444. The QFS 2492 may support volume management capabilities, allowing many disks to be grouped together into a file system. The QFS 2492 may communicate with the database instances 2490, content search servers 2468 and/or indexers 2494 to identify, retrieve, move, and/or update data stored in the network file systems (NFS) 2496 and/or other storage systems.

In some implementations, one or more query servers 2482 may communicate with the NFS 2496 to retrieve and/or update information stored outside of the pod 2444. The NFS 2496 may allow servers located in the pod 2444 to access information over a network in a manner similar to how local storage is accessed. Queries from the query servers 2422 may be transmitted to the NFS 2496 via the load balancer 2428, which may distribute resource requests over various resources available in the on-demand database service environment 2400. The NFS 2496 may also communicate with the QFS 2492 to update the information stored on the NFS 2496 and/or to provide information to the QFS 2492 for use by servers located within the pod 2444.

In some implementations, the content batch servers 2464 may handle requests internal to the pod 2444. These requests may be long-running and/or not tied to a particular customer, such as requests related to log mining, cleanup work, and maintenance tasks. The content search servers 2468 may provide query and indexer functions such as functions allowing users to search through content stored in the on-demand database service environment 2400. The file servers 2486 may manage requests for information stored in the file storage 2498, which may store information such as documents, images, basic large objects (BLOBs), etc. The query servers 2482 may be used to retrieve information from one or more file systems. For example, the query system 2482 may receive requests for information from the app servers 2488 and then transmit information queries to the NFS 2496 located outside the pod 2444. The ACS servers 2480 may control access to data, hardware resources, or software resources called upon to render services provided by the pod 2444. The batch servers 2484 may process batch jobs, which are used to run tasks at specified times. Thus, the batch servers 2484 may transmit instructions to other servers, such as the app servers 2488, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

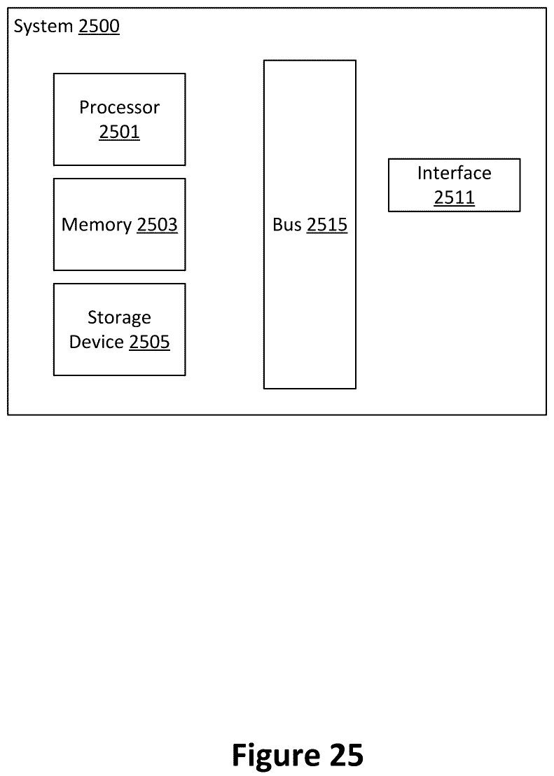

FIG. 25 illustrates one example of a computing device. According to various embodiments, a system 2500 suitable for implementing embodiments described herein includes a processor 2501, a memory module 2503, a storage device 2505, an interface 2511, and a bus 2515 (e.g., a PCI bus or other interconnection fabric.) System 2500 may operate as variety of devices such as an application server, a database server, or any other device or service described herein. Although a particular configuration is described, a variety of alternative configurations are possible. The processor 2501 may perform operations such as those described herein. Instructions for performing such operations may be embodied in the memory 2503, on one or more non-transitory computer readable media, or on some other storage device. Various specially configured devices can also be used in place of or in addition to the processor 2501. The interface 2511 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

### CONCLUSION

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of JSON. However, the techniques of the present invention apply to a wide variety of formatting configurations. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. A computing services environment comprising:
a database system configured to store a plurality of representations of training records associated with a remote robot management system;
an agent platform including metadata entries corresponding to a plurality of agent instances, the metadata entries defining a plurality of actions capable of being autonomously performed within the computing services environment by the plurality of agent instances, the plurality of actions being determined based on the representations of training records associated with the remote robot management system;
a generative language model interface providing access to one or more generative language models; and
an orchestration and planning service configured to instantiate and execute one or more agent instances associated with the remote robot management system, wherein executing one or more agent instances comprises determining one or more actions of the plurality of actions to generate command information for the remote robot management system to perform the one or more actions.

2. The computing services environment of claim 1, wherein the agent platform is configured to:
extract one or more trained operations from the training records; and
determine the plurality of actions based on the one or more trained operations.

3. The computing services environment of claim 2, wherein the agent platform is further configured to:
determine mapping information associated with the one or more trained operations;
identify the plurality of actions based on the mapping information; and
generate a plurality of assets in the computing services environment.

4. The computing services environment of claim 1, wherein the executing of the one or more instances further comprises:
generating program code compatible with an operating system of a remote robot.

5. The computing services environment of claim 1, wherein the command information includes one or more commands for one or more remote robots associated with the remote robot management system.

6. The computing services environment of claim 1, wherein the executing of the one or more agent instances further comprises:
generating service layer integration information for the remote robot management system.

7. The computing services environment of claim 6, wherein the service layer integration information identifies one or more entities associated with a service layer associated with the computing services environment.

8. The computing services environment of claim 1, wherein the command information is generated based on one or more templates associated with the plurality of actions.

9. The computing services environment of claim 8, wherein at least one of the one or more templates is generated for each of the plurality of actions.

10. The computing services environment of claim 1, wherein the agent platform is further configured to:
identify operational flow data associated with an on-demand application; and
generate instructions for the one or more agent instances based, at least in part, on the operational flow data.

11. A method implemented in a computing services environment including a hardware processor and a database system, the method comprising:
storing, in a database system, a plurality of representations of training records associated with a remote robot management system;
storing metadata entries via an agent platform, the metadata entries corresponding to a plurality of agent instances, the metadata entries defining a plurality of actions capable of being autonomously performed within the computing services environment by the plurality of agent instances, the plurality of actions being determined based on the representations of training records associated with the remote robot management system;
providing access to one or more generative language models via a generative language model interface; and
instantiating and executing, using an orchestration and planning service, one or more agent instances associated with the remote robot management system, wherein executing the one or more agent instances comprises determining one or more actions of the plurality of actions to generate command information for the remote robot management system to perform the one or more actions.

12. The method of claim 11 further comprising:
extracting one or more trained operations from the training records; and
determining the plurality of actions based on the one or more trained operations.

13. The method of claim 12 further comprising:
determining mapping information associated with the one or more trained operations;
identifying the plurality of actions based on the mapping information; and
generating a plurality of assets in the computing services environment.

14. The method of claim 11, wherein the command information includes one or more commands for one or more remote robots associated with the remote robot management system.

15. The method of claim 11, wherein the executing of the one or more agent instances further comprises:
generating service layer integration information for the remote robot management system.

16. The method of claim 11 further comprising:
retrieving one or more templates associated with the plurality of actions;
generating the command information based on the one or more templates; and
generating service layer endpoint information based on the one or more templates.

17. The method of claim 11 further comprising:
identifying operational flow data associated with an on-demand application; and
generating instructions for the one or more agent instances based, at least in part, on the operational flow data.

18. One or more non-transitory computer readable media having instructions stored thereon for performing a method implemented in a computing services environment including a hardware processor and a database system, the method comprising:
storing, in a database system, a plurality of representations of training records associated with a remote robot management system;
storing metadata entries via an agent platform, the metadata entries corresponding to a plurality of agent instances, the metadata entries defining a plurality of actions capable of being autonomously performed within the computing services environment by the plurality of agent instances, the plurality of actions being determined based on the representations of training records associated with the remote robot management system;
providing access to one or more generative language models via a generative language model interface; and
instantiating and executing, using an orchestration and planning service, one or more agent instances associated with the remote robot management system, wherein executing the one or more agent instances comprises determining one or more actions of the plurality of actions to generate command information for the remote robot management system to perform the one or more actions.

19. The one or more non-transitory computer readable media of claim 18, wherein the method further comprises:
extracting one or more trained operations from the training records;
determining the plurality of actions based on the one or more trained operations;
determining mapping information associated with the one or more trained operations;
identifying the plurality of actions based on the mapping information; and
generating a plurality of assets in the computing services environment.

20. The one or more non-transitory computer readable media of claim 18, wherein the method further comprises:
identifying operational flow data associated with an on-demand application; and
generating instructions for the one or more agent instances based, at least in part, on the operational flow data.
